(19) United States
(12) Patent Application Publication
(10) Pub. No.: US 2005/0007614 A1
(43) Pub. Date: Jan. 13, 2005

(54) Image forming system, image forming apparatus, operation control method for image forming apparatus, and control program for image forming apparatus

(75) Inventor: Takashi Kishigami, Amagasaki-shi (JP)

Correspondence Address: JORDAN AND HAMBURG LLP, 122 EAST 42ND STREET, SUITE 4000, NEW YORK, NY, 10168, US

(73) Assignee: Kyocera Mita Corporation, Osaka-shi (JP)

(21) Appl. No.: 10/616,324

(22) Filed: Jul. 8, 2003

(51) Int. Cl. G06F 3/12; G06F 15/00; G06F 11/30; H04N 1/50

(52) U.S. Cl. 358/1.13; 710/19; 718/102; 358/1.15

(57) ABSTRACT

An image forming system is disclosed, in which recording materials P1, P2 with monochrome images formed in a first image forming apparatus 3 capable of performing only monochrome printing are set in a post-processing tray 7 of a post-processing device 4 in a second image forming apparatus 2 capable of performing color printing, and either one of operations: one of feeding recording materials P3, P4 through the recording-material feed means 8; another of feeding the recording materials P1, P2 from the post-processing tray 7, is automatically selected according to page numbers. First and second discharge sections 41 and 38 of the post-processing device 6 are operable to serializably discharge the color-printed recording materials P3, P4 and the recording materials P1, P2 onto a recording-material discharge tray 40, respectively, so as to mix monochrome pages and color pages together in order of page number. The present invention can provide an image forming system with simplified structure at a low cost.

### FIELD OF THE INVENTION

The present invention relates to an image forming system comprising a plurality of image forming apparatuses (copiers, printers, facsimile machines and/or combinations thereof and a computer which are connected with each other via a network, wherein the computer is operable to control the operation of the image forming apparatuses so as to perform printing on a recording material. The present invention also relates to an image forming apparatus for use in such an image forming system, an operation control method for the image forming apparatus, and a control program for the image forming apparatus.

### BACKGROUND OF THE INVENTION

There has heretofore been known an image forming system comprising a computer and an image forming apparatus, such as a copier, a printer or a facsimile machine, which are connected with each other via a network, wherein the computer is operable to transmit various job data created therein, for example, to a color or monochrome printer so as to instruct the color or monochrome printer to perform a print job of forming an image on a recording material such as a paper or plastic sheet.

When the above conventional image forming system handles a set of print job data including color and monochrome document data in combination, a user has been obliged to select either one of color and monochrome printers to perform the set of print jobs by using only the selected printer. In such a case, while the color printer may be selected to accomplish the entire jobs therein, it essentially involves a problem of slower print speed and higher cost than those in the monochrome printer. Alternatively, while the entire jobs may be accomplished by using the monochrome printer, the data being originally intended to be color-printed will be monochrome-printed, or the print jobs will be undesirably performed against a user's expectation. As one remaining option, the user may determine if each of document pages is to be color-printed or monochrome-printed and then select one of the printers to be operated with respect to each of the pages. However, this method will undesirably force the user to handle a complicated and cumbersome operation.

From this point of view, there has been recently proposed an improved image forming system disclosed, for example, in Japanese Patent Laid-Open Publication No. 2000-112689. Such a recent improved image forming system is configured to instruct a color printer to perform a job concerning color pages among jobs from a computer so as to print out the color pages from the color printer, and to instruct a monochrome printer to perform a job concerning monochrome pages so as to print out the monochrome pages from the monochrome printer. This conventional image forming system is also configured to allow the color and monochrome printers to print out recording materials together with barcodes representing page information and/or job information with respect to each of the jobs. Then, respective stacks of recording materials printed out from the color and monochrome printers are set in a dedicated machine or collator to read the information on the recording material stacks with respect to each of the jobs from the barcodes so that the color pages and the monochrome pages are mixed together in order of page number.

However, this conventional image forming system is subject to use the particular dedicated machine or collator to mix the respective recording materials from the color and monochrome printers with images formed thereon. Thus, the requirement of incorporating the dedicated machine or collator leads to undesirably complexified structure and increased system cost.

### SUMMARY OF THE INVENTION

It is an object of the present invention to provide an image forming system, an image forming apparatus, an operation control method, and a control program which are free from the problems residing in the prior art.

According to an aspect of the invention, there are provided a computer, a first image forming apparatus for performing only monochrome printing, and a second image forming apparatus for performing color printing. They are connected with each other via a network.

Monochrome-printed recording materials from the first image forming apparatus and color-printed recording materials from the second image forming apparatus are mixed with one another.

Other features and advantages of the present invention will be apparent from the accompanying drawings and from the detailed description.

### BRIEF DESCRIPTION OF THE DRAWINGS

FIG. 1 is a schematic system diagram of an image forming system according to a first embodiment of the present invention.

FIG. 2 is a block diagram of the image forming system according to the first embodiment of the present invention.

FIG. 3 is a flowchart showing the operation control of a computer constituting the image forming system according to the first embodiment of the present invention.

FIG. 4 is a flowchart showing the operation control of a first image forming apparatus constituting the image forming system according to the first embodiment of the present invention.

FIG. 5 is a flowchart showing the operation control of a second image forming apparatus constituting the image forming system according to the first embodiment of the present invention.

FIG. 6 is a conceptual diagram of monochrome pages and color pages.

FIG. 7 is a schematic system diagram of an image forming system according to a second embodiment of the present invention.

FIG. 8 is a block diagram of the image forming system according to the second embodiment of the present invention.

FIG. 9 is a flowchart showing the operation control of a computer constituting the image forming system according to the second embodiment and an image forming system according a third embodiment of the present invention.

FIG. 10 is a flowchart showing the operation control of a first image forming apparatus constituting the image forming system according to the second and third embodiment of the present invention.

FIG. 11 is a flowchart showing the operation control of a second image forming apparatus constituting the image forming system according to the second embodiment of the present invention.

FIG. 12 is a schematic system diagram of the image forming system according to the third embodiment of the present invention.

FIG. 13 is a block diagram of the image forming system according to the third embodiment of the present invention.

FIG. 14 is a flowchart showing the operation control of a second image forming apparatus constituting the image forming system according to the third embodiment of the present invention.

### DESCRIPTION OF THE PREFERRED EMBODIMENT

With reference to the drawings, various embodiments of the present invention will now be described.

[First Embodiment]

(Overall Structure of Image Forming System)

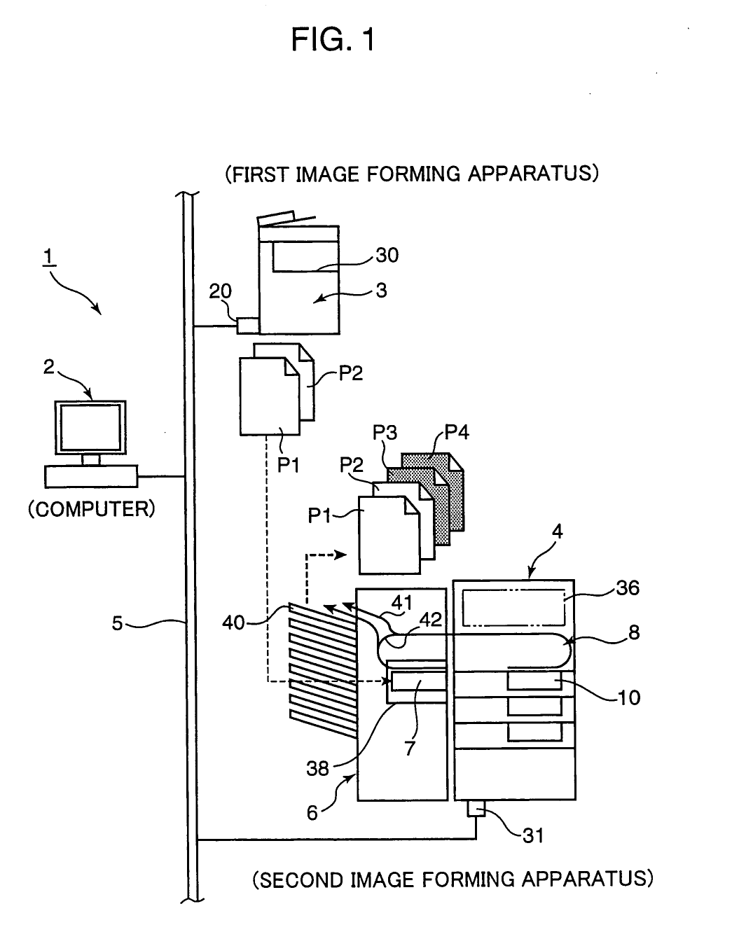

FIG. 1 schematically shows the overall structure of an image forming system 1 according to a first embodiment of the present invention. As shown in this figure, the image forming system 1 comprises one or more computers 2, and a plurality of image forming apparatuses (printers, copiers, facsimile machines, multifunctional complex machines having a network scanner function and others) 3, 4, which are connected with each other via a network 5. The computer 2 can designate one or more of the image forming apparatuses 3, 4, and instruct the image forming apparatuses 3, 4, to perform a specific job. The image forming system 1 of the present invention is configured to allow the computer 2 to acquire information about the operational state of each of the image forming apparatuses 3, 4. The image forming system 1 of the present invention includes both an image forming apparatus 3 capable of performing only monochrome printing (hereinafter referred to as “first image forming apparatus”), and an image forming apparatus 4 capable of performing color printing (hereinafter referred to as “second image forming apparatus”). The image forming system 1 is operable to allow recording materials P1, P2 with monochrome images formed by the first image forming apparatus 3 to be set in a post-processing tray 7 of a post-processing device 6 of the second image forming apparatus 4, and to allow the monochrome-printed recording materials P1, P2 fed from the post-processing tray 7 and recording materials P3, P4 fed from a sheet-feed tray 10 served as a recording-material receiving section, through a recording-material feed means 8 and formed with color images to be mixed with each other while serializing their page numbers in a sequential order (P1-P4). The post-processing device 6 is operable to subject recording materials with images formed thereon to various post-processing such as punching, stapling or folding.

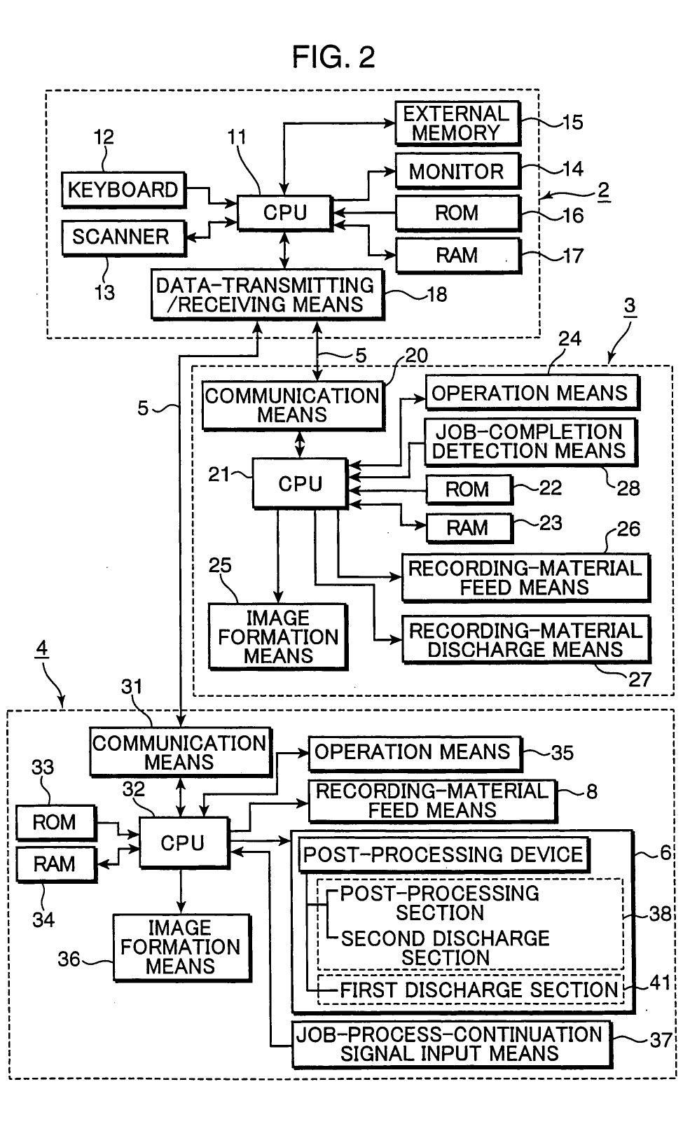

FIG. 2 is a block diagram showing the relationship between the computer 2, the first image forming apparatus 3 and the second image forming apparatus 4.

(Computer)

The computer 2 includes a CPU 11 connected with a keyboard 12, a scanner 13, a monitor 14 and an external memory (hard disk or the like) 15, through an interface (not shown). The keyboard 12 can be used to enter various data therethrough, and the scanner 13 can be operated to import image data. These input data can be displayed on the monitor 14. The computer 2 further includes a ROM 16 readably storing control software (program) and various kinds of application software (program), and a RAM 17 for temporarily storing various data. The computer 2 is operable to read and execute the control software and application software stored in the ROM 16 through the CPU 11 to allow a user to create text data or graphic data and then store the created data. The computer 2 is connected to the network 5 through data transmitting/receiving means 18 so as to transmit/receive various data to/from the first image forming apparatus 3 and the second image forming apparatus 4.

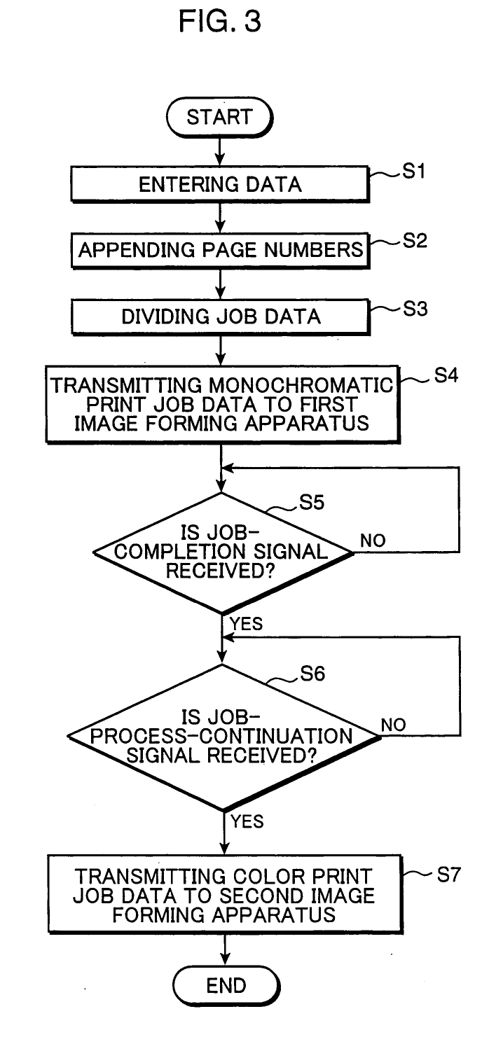

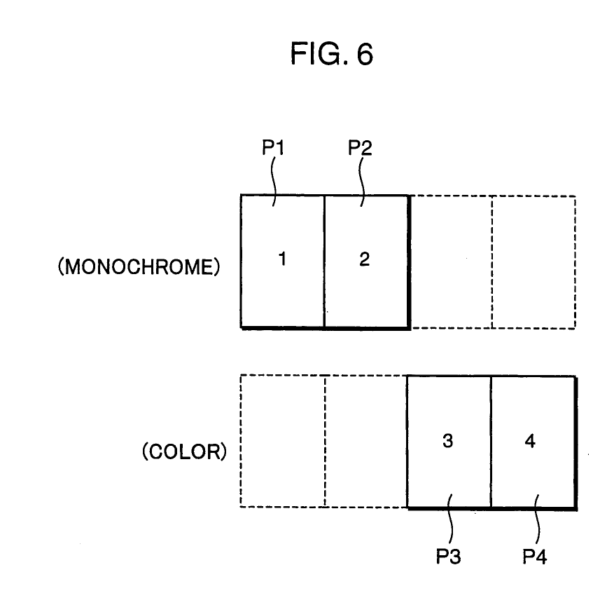

The above computer 2 operates as shown in FIG. 3. When certain data is entered into the computer 2 through the keyboard 12 or any other suitable data input means (Step S1), the input date is divided into plural segments depending on data volume, and a page number is appended to each of the segmented data (Step S2). The pages are divided into one page group each including only monochromatic print data and the other page group each including color print data by discriminating whether each of the pages includes only monochromatic print data or includes color print data (Step S3). Then, the computer 2 transmits data of the page group each including only monochromatic print data (e.g. data of 1st and 2nd pages in FIG. 6) to the first image forming apparatus 3 in order of page number (Step S4). The first image forming apparatus 3 performs a job in accordance with the monochromatic print data from the computer, and transmits a job-completion signal to the computer after the completion of the job.

In response to the reception of a job-process-continuation signal from the second image forming apparatus 4 (Step S6) after receiving the job-completion signal from the first image forming apparatus 3 (Step S5), the computer 2 transmits color print job data to the second image forming apparatus 4 in order of page number (Step S7).

(First Image Forming Apparatus)

The first image forming apparatus 3 or the image forming apparatus capable of performing only monochrome printing is operable to transmit/receive various data to/from the computer 2 through communication means 20 connected to the network 5. The first image forming apparatus 3 includes a CPU 21 (a central processing unit of a computer) connected with memories such as a ROM 22 (for storing programs) and a RAM 23, and it is understood that an external storage device such as hard disk (not shown) may be additionally connected to the CPU 21 through an interface (not shown) according to need. The CPU 21 of the first image forming apparatus 3 is connected with at least operation means 24, image formation means 25, recording-material feed means 26, recording-material discharge means 27 and job-completion detection means 28 through an interface (not shown).

The image formation means 25 includes a photosensitive body onto which an electrostatic latent image is formed, a development device for allowing the electrostatic latent image on the photosensitive body to be visualized as a toner image, a transfer device for transferring the toner image visualized by the development device from the photosensitive body to a recording material (paper sheet, plastic sheet or the like), and a fixing device for fixing the transferred toner image onto the recording material. Using these components, the image formation means 25 is operable to form a monochrome image on the recording material. The operation means 24 is composed of various kinds of data input keys or a liquid-crystal panel with touch panel functions. The recording-material feed means 26 is operable to feed recording materials stacked on a sheet-feed tray serving as a recording-material receiving section, to the image formation means 25 one by one. The recording-material discharge means 27 is operable to discharge the recording materials P1, P2 with monochrome images formed by the image formation means 25, onto a recording-material discharge tray 30 serving as a recording-material stacking means (see FIG. 1). The job-completion detection means 28 includes a discharged-sheet sensor for counting the number of recording materials discharged onto the recording-material discharge tray 30 through the recording-material discharge means 27. The job-completion detection means 28 is configured to detect the completion of a job based on the matching between the number of pages in the monochromatic print data transmitted from the computer 2 and the counted number in the discharged-sheet sensor. The respective operations of the image formation means 25, the recording-material feed means 26 and the recording-material discharge means 27 are controlled by the CPU 21.

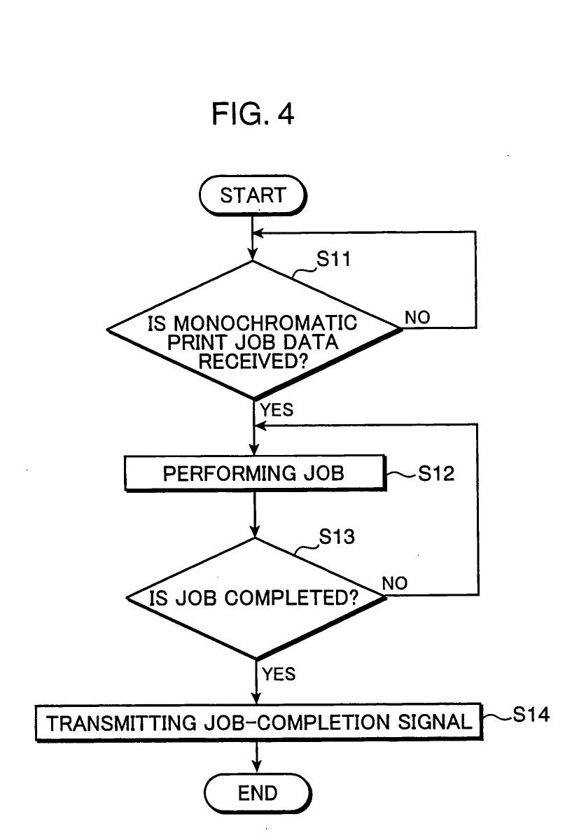

The above first image forming apparatus 3 operates as shown in FIG. 4. When receiving the monochromatic print job data transmitted from the computer 2 (Step S11), the first image forming apparatus 3 performs the print job (Step S12). Specifically, the CPU 21 of the first image forming apparatus 3 drives the recording-material feed means 26 to feed the recording materials P1, P2. The CPU 21 also operates the image formation means 25 to form a monochrome image on each of the recording materials P1, P2, and instructs the recording-material discharge means 27 to discharge the monochrome-printed recording materials onto the recording-material discharge tray 30 in ascending order of page number (in order P1, P2) and in a face-up manner. When the entire print job is completed (Step S13), the first image forming apparatus 3 transmits a job-completion signal representing the completion of the print job to the computer 2 (Step S14). The recording-materials P1, P2 printed out by the first image forming apparatus 3 (or formed with monochrome images and stacked on the recording-material discharge tray 30) will be placed on the post-processing tray 7 of the second image forming apparatus 4 in the same state as that when the recording-materials P1, P2 are discharged on the recording-material discharge tray 30 (or in the state where the recording-materials P1, P2 are stacked in order P1, P2 in a face-up manner) (see FIG. 1).

(Second Image Forming Apparatus)

The second image forming apparatus 4 or the image forming apparatus capable of performing color printing is operable to transmit/receive various data to/from the computer 2 through communication means 31 connected to the network 5. The second image forming apparatus 4 includes a CPU 32 (a central processing unit of a computer) serving as image-formation control means, which is connected with memories such as a ROM 33 (for storing programs) and a RAM 34, and it is understood that an external storage device such as hard disk (not shown) may be additionally connected to the CPU 32 through an interface (not shown) according to need. The CPU 32 of the second image forming apparatus 4 is connected with at least operation means 35, image formation means 36, the recording-material feed means 8, the post-processing device 6 and job-process-continuation-signal input means 37 through an interface (not shown).

The image formation means 36 includes a photosensitive body onto which an electrostatic latent image is formed, a development device for allowing the electrostatic latent image on the photosensitive body to be visualized as a toner image with color (black, yellow, magenta, cyan), a transfer device for transferring the toner image visualized by the development device from the photosensitive body to a recording material (paper sheet, plastic sheet or the like) P3, P4, and a fixing device for fixing the transferred toner image onto the recording material P3, P4. Using these components, the image formation means 36 is operable to form a color image on the recording material. The operation means 35 is composed of various kinds of data input keys or a liquid-crystal panel with touch panel functions. The recording-material feed means 8 is operable to feed recording materials P3, P4 stacked on the sheet-feed tray 10 to the image formation means 36 one by one.

The post-processing device 6 includes a post-processing section 38 for subjecting the color-printed recording materials P3, P4 to a post-processing such as stapling, and a first discharge section 41 for guiding the color-printed recording materials P3, P4 directly to a recording-material discharge tray 40. Specifically, the post-processing section 38 of the post-processing device 6 is operable to guide the recording materials P3, P4, which are color-printed by the image formation means 36 and then released from the recording-material feed means 8, to the post-processing tray 7 through the post-processing feed passage 42, so as to subject the recording materials P3, P4 on the post-processing tray 7 to the post processing such as stapling, and then discharge the post-processed recording materials P3, P4 from the post-processing tray 7 to the recording-material discharge tray 40. The first discharge section 41 of the post-processing device 6 is operable to receive the recording materials P3, P4 released from the recording-material feed means 8, and then guide the received recording materials P3, P4 to the recording-material discharge tray 40. The first discharge section 41 includes a feed mechanism such as feed rollers (not shown) disposed along its feed passage for the recording materials P3, P4. The post-processing tray 7 of the post-processing section 38 can be retractably pulled out to allow the recording materials P1, P2 monochrome-printed by the first image forming apparatus 3 to be placed thereon. The post-processing section 38 can serve as a second discharge section to discharge the recording materials P1, P2 from the post-processing tray 7 onto the recording-material discharge tray 40 without subjecting the recording materials P1, P2 on the post-processing tray 7 to the post-processing.

The above recording materials P1, P2 or the recording materials P1, P2 with monochrome images formed by the first image forming apparatus 3 are placed on the post-processing tray 7 in order of page number (the recording material having a larger page number is located on more upside of the stack) in a face-up manner. Then, when the post-processing section 38 serves as the second discharge section, the recording materials P1, P2 on the post-processing tray 7 are discharged onto the record-material discharge tray 40 in a face-up manner. On the other hand, the recording-materials P3, P4 fed to the image formation means 36 through the recording-material feed means 8 are color-printed by the image formation means 36 in descending order of page number (in order P4, P3), and then discharged onto the recording-material discharge tray 40 in a face-up manner through the first discharge section 41 of the post-processing device 6. Thus, the recording materials will be stacked on the recording-material discharge tray 40 in descending order of page number (in order P4-P1) and in a face-up manner. A conventional sensor (not shown) for detecting the placement of the recording materials is provided in each of the sheet-feed tray 10 and the post-processing tray 7.

The CPU 32 of the second image forming apparatus 4 is operable to check the page numbers of the color print job data transmitted from the computer 2, and switchingly operate either one of the recording-material feed means 8/first discharge section 41 and the post-processing section 38 serving as the second discharge section so as to serialize their page numbers in a sequential order. More specifically, given that the monochrome pages P1, P2 and the color pages P3, P4 correspond to 1st/2nd pages and 3rd/4th page, respectively, as shown in FIG. 6, or the print data including only the respective page numbers of the 3rd and 4th pages is transmitted from the computer 2 to the second image forming apparatus 4, the recording-material feed means 8 and the image formation means 36 are first operated according to a control signal from the CPU 32, in such a manner that the respective data of 4th and 3rd pages are color-printed on the recording materials P4, P3 in this order, and the first discharge section 41 discharges the color-printed recording materials P4, P3 onto the recording-material discharge tray 40 in descending order (in order P4, P3) and in a face-up manner. Then, the post-processing section 38 serving as the second discharge section is operated according to a control signal from the CPU 32, so as to sequentially discharge the 2nd page (P2) and 1st page (P1) of the monochrome pages from the post-processing tray 7 onto the recording-material discharge tray 40 in descending order (P2-P1). Thus, the recording materials P4-P1 formed with monochrome and color images will be stacked on the recording-material discharge tray 40 in a face-up manner while being mixed together in order of page number.

The job-process-continuation-signal input means 37 includes input keys incorporated in an operation panel, a liquid-crystal display panel or the like. When the recording materials P1, P2 monochrome-printed by the first image forming apparatus 3 are placed on the post-processing tray 7 of the post-processing device 6, the aforementioned sensor (not shown) provided in the post-processing tray 7 detects the placement to enable the ON operation of the job-process-continuation-signal input means 37. If an ON signal is entered from the job-process-continuation-signal input means 37, a corresponding the job-process-continuation signal is transmitted from the second image forming apparatus 4 to the computer 2. In response to the reception of the job-process-continuation signal, the computer 2 transmits the color print data to the second image forming apparatus 4 to allow the second image forming apparatus 4 to initiate the print job.

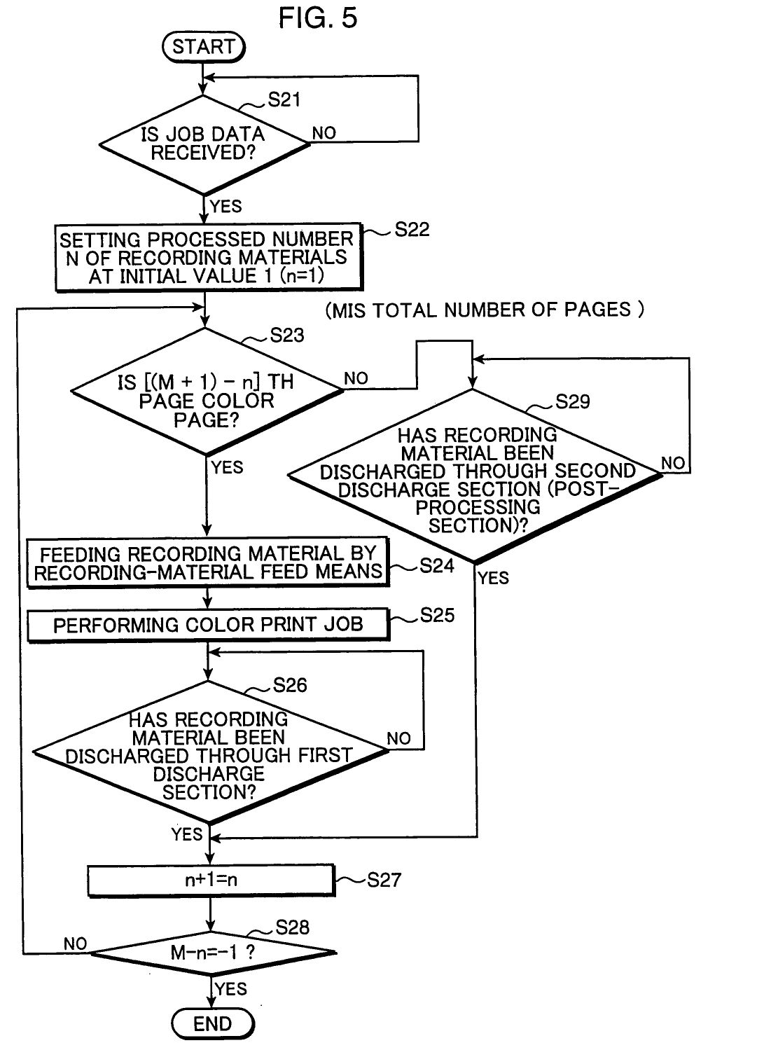

FIG. 5 is a flowchart showing the operation control of the second image forming apparatus 4 constructed as above. As shown in FIG. 5, when the second image forming apparatus 4 receives the job data transmitted from the computer 2 (Step S21), the processed number of recording materials is set at an initial value n=1 by the CPU 32 serving as the image formation control means (Step S22). Then, the CPU 32 checks the page numbers of the color print job data and the page numbers of the monochromatic print job data, and switchingly operates either one of the recording-material feed means 8 and the post-processing section 38 serving as the second discharge section, in descending order of page number (in order from lager page number to smaller page number). For example, given that the number of pages to be printed in the job data is M, if a Mth page is determined as a color page (Step S23), the recording-material feed means 8 feeds a recording material (Step S24, and the image formation means 36 forms a color image on the recording material (Step S 25). Then, the recording material with color image formed thereon is discharged onto the recording-material discharge tray 40 in a face-up manner through the first discharge section 41 of the post-processing device 6 (Step S26). When the discharge of the recording material onto the recording-material discharge tray 40 is detected by the sensor, the processed number n of recording materials is added with one (Step S27). Then, the CPU 32 determines if the entire recording materials have been processed (Step S28). If it is determined that the entire recording-materials have been processed, the operation of mixing the recording materials will be terminated. At Step S28, if it is determined that the recording materials have not been completely processed, the CPU 32 will determine if a [(M+1)−n] th page is a color page (Step S23). If the page is determined as a color page, the process from Step S24 to Step S28 will be repeatedly performed.

At Step S23, if the page data in question is determined as a monochrome page, the recording material on the post-processing tray 7 is discharged onto the recording-material discharge tray 40 in a face-up manner through the post-processing section 38 serving as the second discharge section of the post-processing device 6 (Step S29). When the discharge of the recording material onto the recording-material discharge tray 40 is detected by the sensor, the processed number n of recording materials is added with one (Step S27). Then, the CPU 32 determines if the entire recording-materials have been processed (Step S28). If it is determined that the recording materials have not been completely processed, the process will return to Step S23 and perform the job. If it is determined that the entire recording materials have been processed, the operation of mixing the recording materials will be terminated. Through the above series of operations, the pages with only monochrome images and the pages with color images will be stacked on the recording-material discharge tray 40 while being mixed together in order of page number.

(Effect of First Embodiment)

As mentioned above, according to the first embodiment of the present invention, a monochrome image is printed on each of recording materials P1, P2 by use of the first image forming apparatus 3 capable of performing only monochrome printing, and the monochrome-printed recording materials P1, P2 are set on the post-processing tray 7 of the post-processing device 6 in the second image forming apparatus 4 capable of performing color printing. Then, according to the page numbers, either one of operations: one of feeding the recording materials P3, P4 through the recording-material feed means 8 and discharging the color-printed recording material P3, P4 onto the recording-material discharge tray 40 through the first discharge section 41 of the post-processing device 6; another of feeding the recording materials P1, P2 through the post-processing section 38 of the post-processing device 6 to discharge the monochrome-printed recording materials P1, P2 onto the recording-material discharge tray 40 through the post-processing section 38 serving as second discharge section of the post-processing device 6, is automatically selected. Thus, even if job data includes monochromatic print data and color print data in combination, the recording materials P4-P1 with color and monochrome pages can be stacked on the recording-material discharge tray 40 while being mixed in order of page number. The image forming system 1 according to the first embodiment can eliminate the need for any dedicated machine, such as collator, for mixing monochrome-printed pages and color-printed pages together, to facilitate cost reduction in the image forming system 1.

(Modification of First Embodiment)

The present invention is not limited to the above specific construction in the first embodiment. For example, after job data is divided into monochromatic print data and color print data, the divided data may be simultaneously transmitted, respectively, to the first image forming apparatus 3 and the second forming apparatus 4, and the second image forming apparatus 4 may be configured to perform the operation as shown in FIG. 5 in response to the ON operation of the job-process-continuation signal input means 37. As with the first embodiment, the ON operation of the job-process-continuation signal input means 37 in this modification is enabled only after the recording materials P1, P2 with monochrome images formed by the first image forming apparatus are set on the post-processing tray 7 of the post-processing device 6.

[Second Embodiment]

(Overall Structure of Image Forming System)

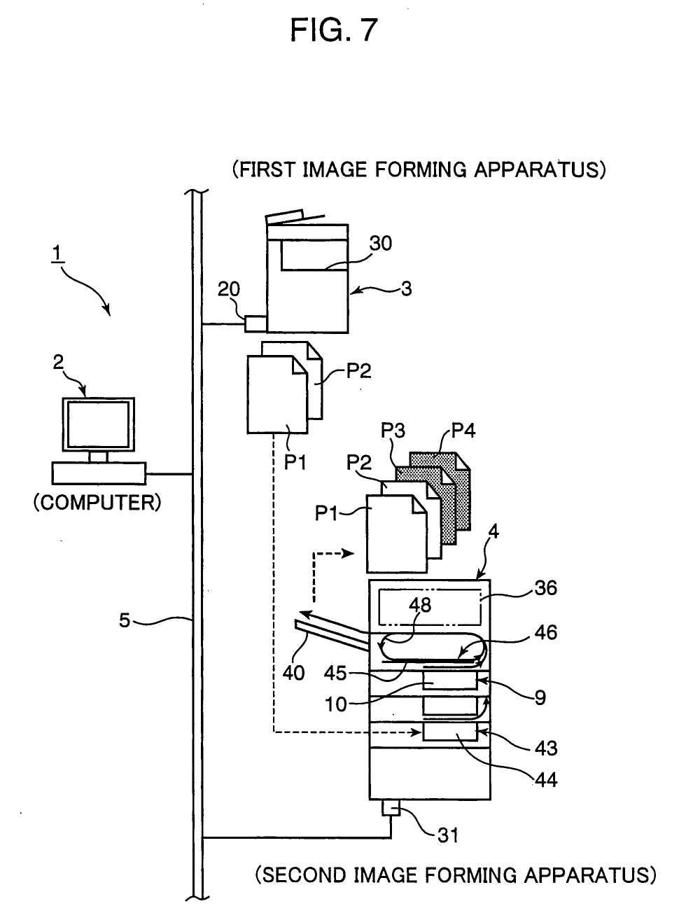

FIG. 7 schematically shows the overall structure of an image forming system 1 according to a second embodiment of the present invention. As shown in FIG. 7, the image forming system 1 comprises one or more computers 2, and a plurality of image forming apparatuses (printers, copiers, facsimile machines, multifunctional complex machines having a network scanner function and others) 3, 4, which are connected with each other via a network 5. The computer 2 can designate one or more of the image forming apparatuses 3, 4, and instruct the image forming apparatuses 3, 4, to perform a specific job. The image forming system 1 of the present invention is configured to allow the computer 2 to acquire information about the operational state of each of the image forming apparatuses 3, 4. The image forming system 1 of the present invention includes both an image forming apparatus 3 capable of performing only monochrome printing (hereinafter referred to as “first image forming apparatus”), and an image forming apparatus 4 capable of performing color printing (hereinafter referred to as “second image forming apparatus”). The image forming system 1 is operable to allow recording materials P1, P2 with monochrome images formed by the first image forming apparatus 3 to be set in a sheet-feed tray 44 of third recording-material feed means 43 of the second image forming apparatus 4, and to allow the monochrome-printed recording materials P1, P2 discharged from the sheet-feed tray 44 to the recording-material discharge tray 40 and recording materials P3, P4 discharged from a double-side-printing intermediate tray 45 after fed from a sheet-feed tray 10 of first recording-material feed means and formed with color images, to a recording-material discharge tray 40 without being subjected to any additional color-printing, to be mixed with each other while serializing their page numbers in a sequential order (P1-P4).

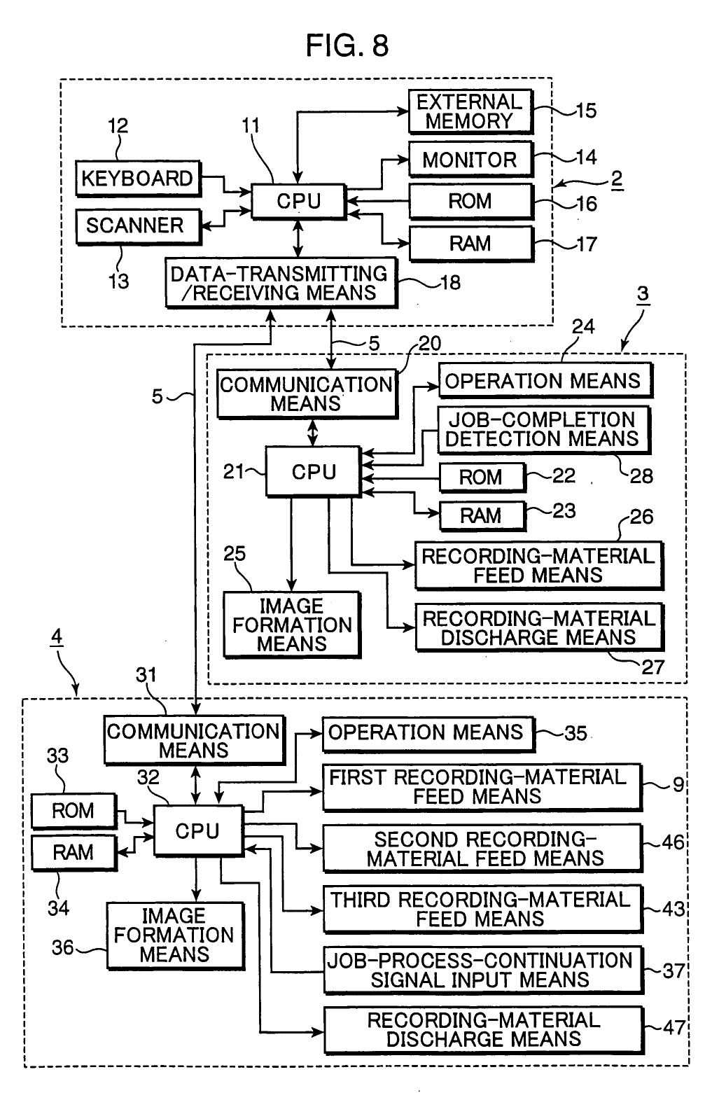

FIG. 8 is a block diagram showing the relationship between the computer 2, the first image forming apparatus 3 and the second image forming apparatus 4.

(Computer)

The computer 2 includes a CPU 11 connected with a keyboard 12, a scanner 13, a monitor 14 and an external memory (hard disk or the like) 15, through an interface (not shown). The keyboard 12 can be used to enter various data therethrough, and the scanner 13 can be operated to import image data. These input data can be displayed on the monitor 14. The computer 2 further includes a ROM 16 readably storing control software and various kinds of application software, and a RAM 17 for temporarily storing various data. The computer 2 is operable to read and execute the control software and application software stored in the ROM 16 through the CPU 11 to allow a user to create text data or graphic data and then store the created data. The computer 2 is connected to the network 5 through data transmitting/receiving means 18 so as to transmit/receive various data to/from the first image forming apparatus 3 and the second image forming apparatus 4.

The above computer 2 operates as shown in FIG. 3. When certain data is entered into the computer 2 through the keyboard 12 or any other suitable data input means (Step S1), the input date is divided into plural segments depending on data volume, and a page number is appended to each of the segmented data (Step S2). The pages are divided into one page group each including only monochromatic print data and the other page group each including color print data by discriminating whether each of the pages includes only monochromatic print data or includes color print data (Step S3). Then, the computer 2 transmits data of the page group each including only monochromatic print data (e.g. data of 1st and 2nd pages in FIG. 6) to the first image forming apparatus 3 in order of page number (Step S4). The computer 2 also transmits the entire print data to the second image forming apparatus 4.

(First Image Forming Apparatus)

The first image forming apparatus 3 or the image forming apparatus capable of performing only monochrome printing is operable to transmit/receive various data to/from the computer 2 through communication means 20 connected to the network 5. The first image forming apparatus 3 includes a CPU 21 connected with memories such as a ROM 22 and a RAM 23, and it is understood that an external storage device such as hard disk (not shown) may be additionally connected to the CPU 21 through an interface (not shown) according to need. The CPU 21 of the first image forming apparatus 3 is connected with at least operation means 24, image formation means 25, recording-material feed means 26, recording-material discharge means 27 and job-completion detection means 28 through an interface (not shown).

The image formation means 25 includes a photosensitive body onto which an electrostatic latent image is formed, a development device for allowing the electrostatic latent image on the photosensitive body to be visualized as a toner image, a transfer device for transferring the toner image visualized by the development device from the photosensitive body to a recording material (paper sheet, plastic sheet or the like), and a fixing device for fixing the transferred toner image onto the recording material. Using these components, the image formation means 25 is operable to form a monochrome image on the recording material. The operation means 24 is composed of various kinds of data input keys or a liquid-crystal panel with touch panel functions. The recording-material feed means 26 is operable to feed recording materials stacked on a sheet-feed tray serving as a recording-material receiving section, to the image formation means 25 one by one. The recording-material discharge means 27 is operable to discharge the recording materials P1, P2 with monochrome images formed by the image formation means 25, onto a recording-material discharge tray 30 serving as a recording-material stacking means, in order of page number (in order P1, P2) and in a face-down manner (see FIG. 7). The job-completion detection means 28 includes a discharged-sheet sensor for counting the number of recording materials P1, P2 discharged onto the recording-material discharge tray 30 through the recording-material discharge means 27. The job-completion detection means 28 is configured to detect the completion of a job based on the matching between the number of pages in the monochromatic print data transmitted from the computer 2 and the counted number in the discharged-sheet sensor. The respective operations of the image formation means 25, the recording-material feed means 26 and the recording-material discharge means 27 are controlled by the CPU 21.

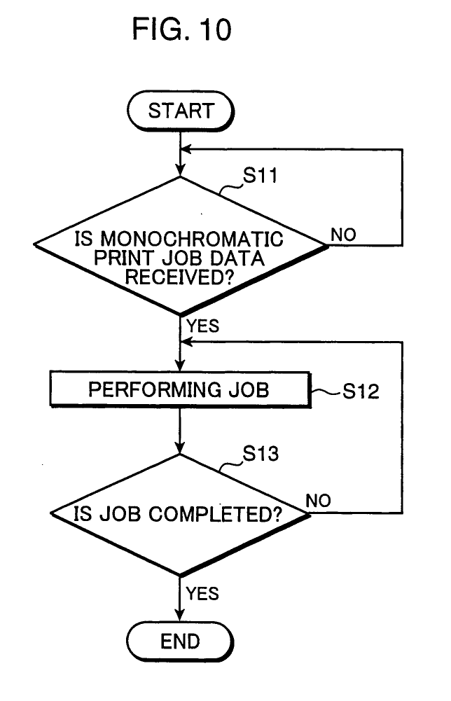

The above first image forming apparatus 3 operates as shown in FIG. 10. When receiving the monochromatic print job data transmitted from the computer 2 (Step S11), the first image forming apparatus 3 performs the print job (Step S12). Specifically, the CPU 21 of the first image forming apparatus 3 drives the recording-material feed means 26 to feed the recording materials P1, P2. The CPU 21 also operates the image formation means 25 to form a monochrome image on each of the recording materials P1, P2, and instructs the recording-material discharge means 27 to discharge the recording materials formed with monochrome images, onto the recording-material discharge tray 30 in order of page number. Then, the first image forming apparatus 3 performs the print job until the completion of the entire print job (Step S13). The recording-materials P1, P2 printed out by the first image forming apparatus 3 (or formed with monochrome images and stacked on the recording-material discharge tray 30) will be placed on the sheet-feed tray 44 of the third recording-material feed means 43 of the second image forming apparatus 4 in order of page number (in order P1, P2) and in a face-down manner (see FIG. 7).

(Second Image Forming Apparatus)

The second image forming apparatus 4 or the image forming apparatus capable of performing color printing is operable to transmit/receive various data to/from the computer 2 through communication means 31 connected to the network 5. The second image forming apparatus 4 includes a CPU 32 serving as image-formation control means, which is connected with memories such as a ROM 33 and a RAM 34, and it is understood that an external storage device such as hard disk (not shown) may be additionally connected to the CPU 32 through an interface (not shown) according to need. The CPU 32 of the second image forming apparatus 4 is connected with at least operation means 35, image formation means 36, the first recording-material feed means 9, second recording-material feed means 46, third recording-material feed means 43, job-process-continuation-signal input means 37 and recording-material discharge means 47 through an interface (not shown).

The image formation means 36 includes a photosensitive body onto which an electrostatic latent image is formed, a development device for allowing the electrostatic latent image on the photosensitive body to be visualized as a toner image with color (black, yellow, magenta, cyan), a transfer device for transferring the toner image visualized by the development device from the photosensitive body to a recording material (paper sheet, plastic sheet or the like) P3, P4, and a fixing device for fixing the transferred toner image onto the recording material P3, P4. Using these components, the image formation means 36 is operable to form a color image on the recording material. The operation means 35 is composed of various kinds of data input keys or a liquid-crystal panel with touch panel functions. The first recording-material feed means 9 is operable to feed recording materials P3, P4 stacked on the sheet-feed tray 10 to the image formation means 36 one by one.

The second recording-material feed means 46 is operable to feed the recording materials P3, P4 on the double-side-printing intermediate tray 45 disposed in a double-side-printing feed passage 48, to the image formation means 36 one by one. The double-side-printing feed passage 48 is configured to allow the recording materials P3, P4 fed from the first recording-material feed means 9 to be color-printed by the image formation means 36 and then placed on the intermediate tray 45 in order of page number (in order P3, P4) and in a face-down manner. The recording materials P3, P4 placed on the intermediate tray 45 will be extracted by the second recording-material feed means 46 in order from the recording material having a larger page number.

The third recording-material feed means 43 is operable to feed the recording materials P1, P2 placed on the sheet-feed tray 44. In this embodiment, the recording materials P1, P2 monochrome-printed by the first image forming apparatus 3 are placed on the sheet-feed tray 44 in order of page number (in ascending order of page number or in order P1, P2 and in a face-down manner). Thus, the recording materials P1, P2 on the sheet-feed tray 44 will be discharged in order from the recording material having a larger page number. Then, the recording-material discharge means 47 is operable to discharge the recording materials P4, P3 fed from the second recording-material fed means 46 and the recording materials P2, P1 fed from the third recording-material fed means 43, onto the recording-material discharge tray 40 in descending order of page number (in order P4-P1) and in a face-up manner. A sensor (not shown) for detecting the placement of the recording materials is provided in each of the sheet-feed trays 10, 44 and the intermediate tray 45.

The CPU 32 of the second image forming apparatus 4 is operable to check the page numbers of the job data, and switchingly operate either one of the second recording-material feed means 46 and the third recording-material feed means 43 so as to serialize their page numbers in a sequential order. More specifically, given that the monochrome pages P1, P2 and the color pages P3, P4 correspond to 1st/2nd pages and 3rd/4th pages, respectively, as shown in FIG. 6, the recording materials placed on the intermediate tray 45 in order P3, P4 and in a face-down manner are fed by the second recording-material feed means 46 in order P4, P3. When the recording materials P4, P3 are fed by the second recording-material feed means 46, the operation of the image formation means 36 is disabled to prevent the recording materials P4, P3 from being color-printed. Then, the recording-material discharge means 47 discharges the recording materials P4, P3 fed from the second recording-material feed means 46, onto the recording-material discharge tray 40 in order P4, P3 and in a face-up manner.

Subsequently, the recording materials stacked and placed on the sheet-feed tray 44 in order P1, P2 and in a face-down manner are fed by the third recording-material feed means 43 in order P2, P1. When the recording materials P2, P1 are fed by the third recording-member feed means 43, the operation of the image formation means 36 is disabled to prevent the recording materials P2, P1 from being color-printed. Then, the recording-material discharge means 47 discharges the recording materials P2, P1 fed from the third recording-member feed means 43, onto the recording-material discharge tray 40 in order P2, P1 and in a face-up manner. Thus, the recording materials formed with monochrome and color images will be stacked on the recording-material discharge tray 40 in a face-up manner while being mixed together in order of page number (in order P4-P1).

The job-process-continuation-signal input means 37 includes input keys incorporated in an operation panel, a liquid-crystal display panel or the like. When the recording materials P1, P2 monochrome-printed by the first image forming apparatus 3 are placed on the sheet-feed tray 44 of the third recording-material feed means 43, the aforementioned sensor (not shown) provided in the sheet-feed tray 44 detects the placement to enable the ON operation of the job-process-continuation-signal input means 37. If an ON signal is entered from the job-process-continuation-signal input means 37, the above mixing operation will be performed by the second recording-material fed means 46 and the third recording-material fed means 43.

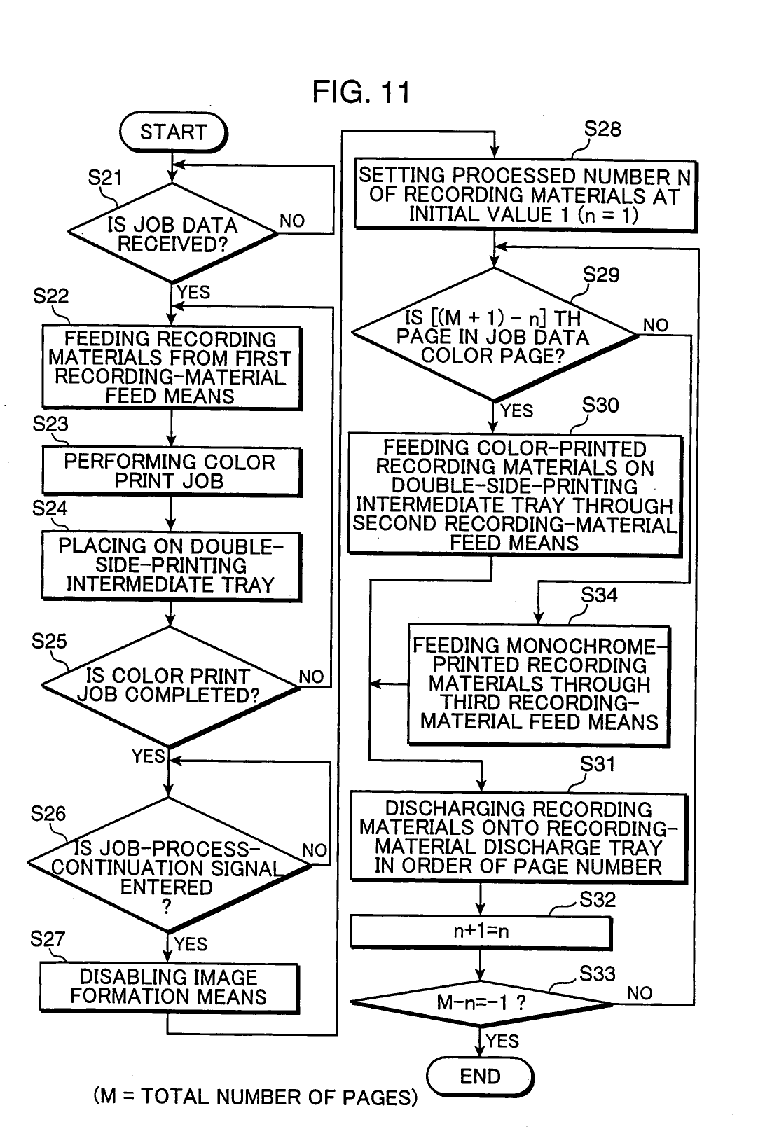

FIG. 11 is a flowchart showing the operation control of the second image forming apparatus 4 constructed as above. As shown in FIG. 11, when the second image forming apparatus 4 receives the job data transmitted from the computer 2 (Step S21), the recording materials P3, P4 are fed by the first recording-material feed means 9 (Step S22), and a color image is formed on each of the recording materials P3, P4 by the image formation means 36 (Step S23). Then, the color-printed recording materials P3, P4 are stacked on the double-side-printing intermediate tray 45 in ascending order of page number (in order P3, P4) (Step S24).

After the completion of the color print job (Step S26), if the job-process-continuation signal is entered from the job-process-continuation signal input means 37 (Step S26), the operation of the image formation means 36 is disabled (Step S27), and the processed number n of recording materials is set at an initial value n=1 by the CPU 32 (Step S28). Then, the CPU 32 determines if a [(M+1)−n] th page in the received job data is a color page (Step S29). If the n-th page is determined as a color page, the color-printed recording materials on the double-side-printing intermediate tray 45 will be fed by the second recording-material feed means 46 in order from P4 (Step S30), and then discharged onto the recording-material discharge tray 40 by the recording-material discharge means 47 in a face-up manner (Step S31).

Then, the CPU adds one to the processed number n of recording materials (Step S32), and determines if the entire recording-materials on the intermediate tray 45 and the sheet-feed tray 44 have been fed by the second recording-material feed means 46 and the third recording-material feed means 43, respectively (Step S33). If M−n>−1, the process will return to Step S29 to perform the above processing. At Step S29, if the CPU 32 determines that the job data for the [(M+1)−n] th page indicates a monochrome page, the monochrome-printed recording materials will be fed by the third recording-material feed means 43 in order from P2 (Step S34), and then discharged onto the recording-material discharge tray 40 by the recording-material discharge means 47 in a face-up manner (Step S30).

At Step S33, if the CPU 32 determines that M−n=−1 after adding one to the processed number n of recording materials, the entire processing will be terminated. Through the above series of operations, the color-printed recording materials P4, P3 and monochrome-printed recording materials P2, P1 will be stacked on the recording-material discharge tray 40 while being mixed together in descending order of page number (in order P4-P1). That is, in the second embodiment, the recording materials P1-P4 are stacked on the recording-material discharge tray 40 in order P4-P1 and in a face-up manner.

(Effect of Second Embodiment)

As mentioned above, according to the second embodiment of the present invention, the monochromatic print job is performed in the first image forming apparatus 3, and the color print job is simultaneously performed in the second image forming apparatus 4. The monochrome-printed recording materials P1, P2 are set on the sheet-feed tray 44 of the third recording-material feed means 43 in the second image forming apparatus 4, and the color-printed recording materials P3, P4 are stocked in the double-side-printing intermediate tray 45 in the second image forming apparatus 4. Then, according to the page numbers, either one of operations: one of feeding the recording materials P3, P4 on the intermediate tray 45 through the second recording-material feed means 46; another of feeding the recording materials P1, P2 on the sheet-feed tray 44 through the third recording-material feed means 43, is selected to discharge the recording materials fed from the second recording-material feed means 46 or the third recording-material feed means 43, onto the recording-material discharge tray 40. Thus, the recording materials P1-P4 with color and monochrome pages can be stacked on the recording-material discharge tray 40 while being mixed in order of page number. The image forming system 1 according to the second embodiment can eliminate the need for any dedicated machine, such as collator, for mixing monochrome-printed pages and color-printed pages together, to facilitate cost reduction in the image forming system 1.

In addition, the image forming system 1 according to the second embodiment allows monochromatic print data and color print data to be simultaneously processed. Thus, the processing time of print jobs can be desirably reduced as compared to a process of performing a color print job after the completion of a monochromatic print job.

[Third Embodiment]

(Overall Structure of Image Forming System)

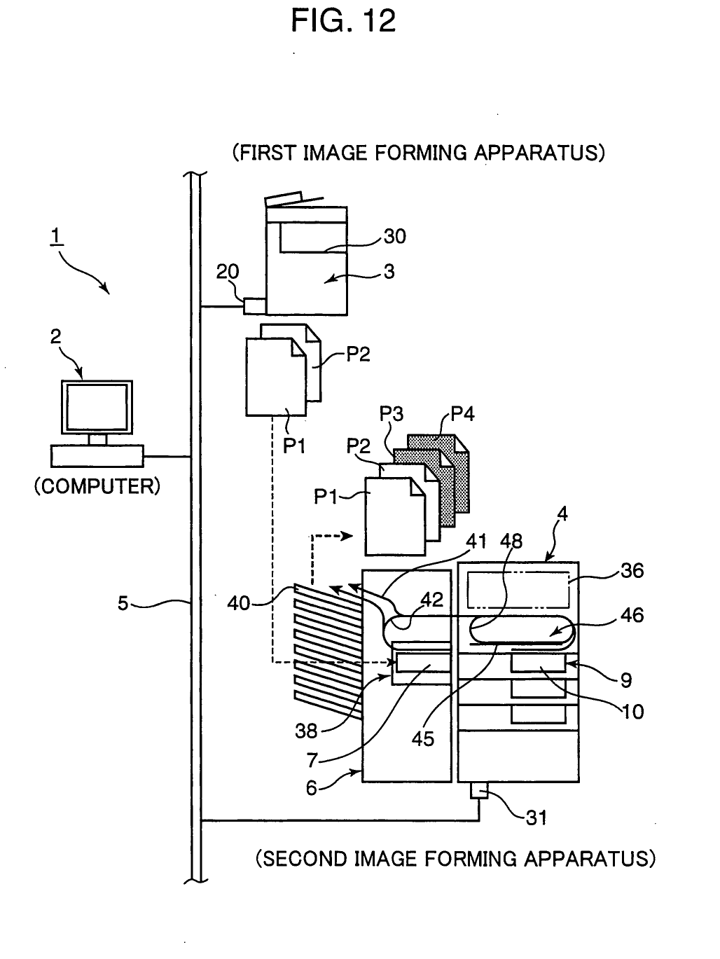

FIG. 12 schematically shows the overall structure of an image forming system 1 according to a third embodiment of the present invention. As shown in FIG. 12, the image forming system 1 comprises one or more computers 2, and a plurality of image forming apparatuses (printers, copiers, facsimile machines, multifunctional complex machines having a network scanner function and others) 3, 4, which are connected with each other via a network 5. The computer 2 can designate one or more of the image forming apparatuses 3, 4, and instruct the image forming apparatuses 3, 4, to perform a specific job. The image forming system 1 of the present invention is configured to allow the computer 2 to acquire information about the operational state of each of the image forming apparatuses 3, 4. The image forming system 1 of the present invention includes both an image forming apparatus 3 capable of performing only monochrome printing (hereinafter referred to as “first image forming apparatus”), and an image forming apparatus 4 capable of performing color printing (hereinafter referred to as “second image forming apparatus”). In the image forming system 1, the first image forming apparatus 3 and the second image forming apparatus 4 can simultaneously perform a monochromatic print job and a color print job, respectively. The color-printed recording materials is stocked in a double-side-printing intermediate tray 45 of the second image forming apparatus 4 in order of page number, and the monochrome-printed recording materials are set in a post-processing tray 7 of a post-processing device 6 of the second image forming apparatus 4 in order of page number. Then, the recording materials can be discharged from the intermediate tray 45 or the post-processing tray 7 onto a recording-material discharge tray 40 so as to stack the color-printed recording materials and the monochrome-printed recording materials on the recording-material discharge tray 40 while mixing them together in order of page number.

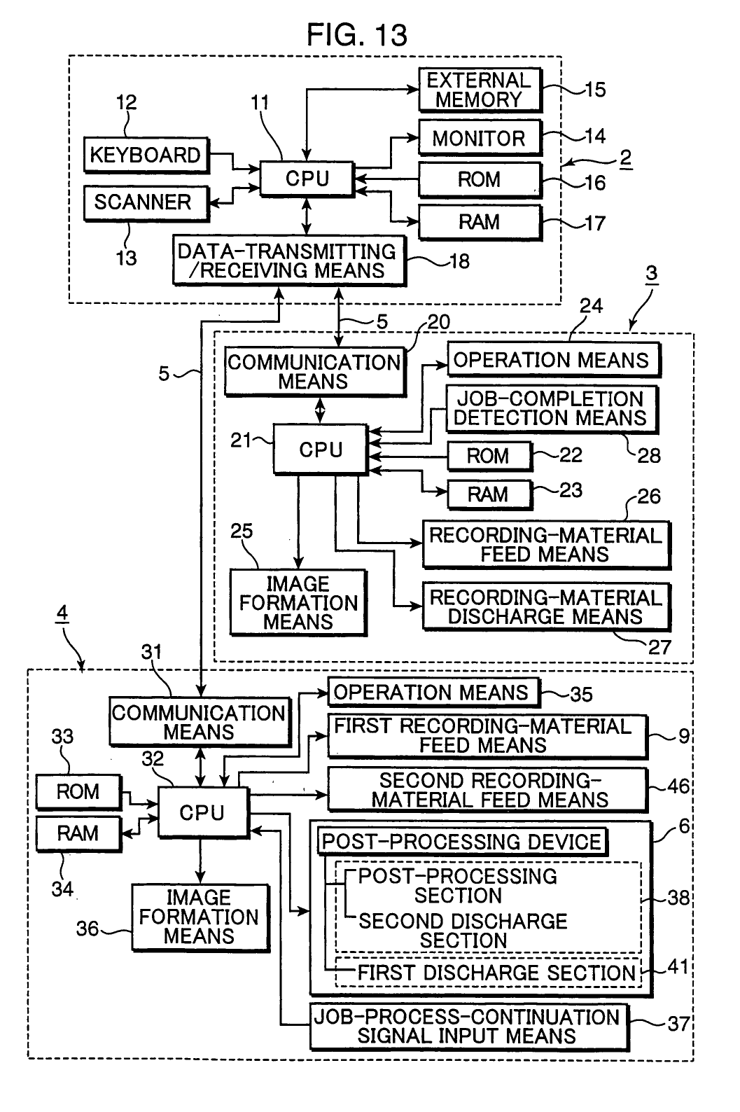

FIG. 13 is a block diagram showing the relationship between the computer 2, the first image forming apparatus 3 and the second image forming apparatus 4.

(Computer)

The computer 2 includes a CPU 11 connected with a keyboard 12, a scanner 13, a monitor 14 and an external memory (hard disk or the like) 15, through an interface (not shown). The keyboard 12 can be used to enter various data therethrough, and the scanner 13 can be operated to import image data. These input data can be displayed on the monitor 14. The computer 2 further includes a ROM 16 readably storing control software and various kinds of application software, and a RAM 17 for temporarily storing various data. The computer 2 is operable to read and execute the control software and application software stored in the ROM 16 through the CPU 11 to allow a user to create text data or graphic data and then store the created data. The computer 2 is connected to the network 5 through data transmitting/receiving means 18 so as to transmit/receive various data to/from the first image forming apparatus 3 and the second image forming apparatus 4.

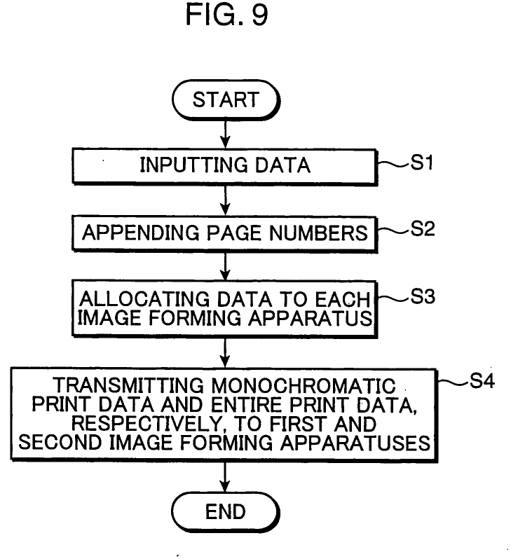

The above computer 2 operates as shown in FIG. 9. When certain data is entered into the computer 2 through the keyboard 12 or any other suitable data input means (Step S1), the input date is divided into plural segments depending on data volume, and a page number is appended to each of the segmented data (Step S2). The pages are divided into one page group each including only monochromatic print data and the other page group each including color print data by discriminating whether each of the pages includes only monochromatic print data or includes color print data (Step S3). Then, the computer 2 transmits data of the page group each including only monochromatic print data (e.g. data of 1st and 2nd pages in FIG. 6) to the first image forming apparatus 3 in order of page number (Step S4). The computer 2 also transmits the entire print data to the second image forming apparatus 4.

(First Image Forming Apparatus)

The first image forming apparatus 3 or the image forming apparatus capable of performing only monochrome printing is operable to transmit/receive various data to/from the computer 2 through communication means 20 connected to the network 5. The first image forming apparatus 3 includes a CPU 21 connected with memories such as a ROM 22 and a RAM 23, and it is understood that an external storage device such as hard disk (not shown) may be additionally connected to the CPU 21 through an interface (not shown) according to need. The CPU 21 of the first image forming apparatus 3 is connected with at least operation means 24, image formation means 25, recording-material feed means 26, recording-material discharge means 27 and job-completion detection means 28 through an interface (not shown).

The image formation means 25 includes a photosensitive body onto which an electrostatic latent image is formed, a development device for allowing the electrostatic latent image on the photosensitive body to be visualized as a toner image, a transfer device for transferring the toner image visualized by the development device from the photosensitive body to a recording material (paper sheet, plastic sheet or the like), and a fixing device for fixing the transferred toner image onto the recording material. Using these components, the image formation means 25 is operable to form a monochrome image on the recording material. The operation means 24 is composed of various kinds of data input keys or a liquid-crystal panel with touch panel functions. The recording-material feed means 26 is operable to feed recording materials stacked on a sheet-feed tray serving as a recording-material receiving section, to the image formation means 25 one by one. The recording-material discharge means 27 is operable to discharge the recording materials P1, P2 with monochrome images formed by the image formation means 25, onto a recording-material discharge tray 30 serving as a recording-material stacking means, in order of page number (see FIG. 12). In the third embodiment, the recording materials are stacked on the recording-material discharge tray 30 in order P1, P2 and in a face-up manner. The job-completion detection means 28 includes a discharged-sheet sensor for counting the number of recording materials discharged onto the recording-material discharge tray 30 through the recording-material discharge means 27. The job-completion detection means 28 is configured to detect the completion of a job based on the matching between the number of pages in the monochromatic print data transmitted from the computer 2 and the counted number in the discharged-sheet sensor. The respective operations of the image formation means 25, the recording-material feed means 26 and the recording-material discharge means 27 are controlled by the CPU 21.

The above first image forming apparatus 3 operates as shown in FIG. 10. When receiving the monochromatic print job data transmitted from the computer 2 (Step S11), the first image forming apparatus 3 performs the print job (Step S12). Specifically, the CPU 21 of the first image forming apparatus 3 drives the recording-material feed means 26 to feed the recording materials P1, P2. The CPU 21 also operates the image formation means 25 to form a monochrome image on each of the recording materials P1, P2, and instructs the recording-material discharge means 27 to discharge the recording materials formed with monochrome images, onto the recording-material discharge tray 30 in order of page number (in order P1, P2). Then, the first image forming apparatus 3 performs the print job until the completion of the entire print job (Step S13). The recording-materials P1, P2 printed out by the first image forming apparatus 3 (or formed with monochrome images and stacked on the recording-material discharge tray 30) will be placed on the post-processing tray 7 of the post-processing device 6 of the second image forming apparatus 4 in order of page number (in order P1, P2) and in a face-up manner (see FIG. 12).

(Second Image Forming Apparatus)

The second image forming apparatus 4 or the image forming apparatus capable of performing color printing is operable to transmit/receive various data to/from the computer 2 through communication means 31 connected to the network 5. The second image forming apparatus 4 includes a CPU 32 serving as image-formation control means, which is connected with memories such as a ROM 33 and a RAM 34, and it is understood that an external storage device such as hard disk (not shown) may be additionally connected to the CPU 32 through an interface (not shown) according to need. The CPU 32 of the second image forming apparatus 4 is connected with at least operation means 35, image formation means 36, the first recording-material feed means 9, second recording-material feed means 46, the post-processing device 6, and job-process-continuation-signal input means 37, through an interface (not shown).

The image formation means 36 includes a photosensitive body onto which an electrostatic latent image is formed, a development device for allowing the electrostatic latent image on the photosensitive body to be visualized as a toner image with color (black, yellow, magenta, cyan), a transfer device for transferring the toner image visualized by the development device from the photosensitive body to a recording material (paper sheet, plastic sheet or the like) P3, P4, and a fixing device for fixing the transferred toner image onto the recording material P3, P4. Using these components, the image formation means 36 is operable to form a color image on the recording material. The operation means 35 is composed of various kinds of data input keys or a liquid-crystal panel with touch panel functions. The first recording-material feed means 9 is operable to feed recording materials P3, P4 stacked on the sheet-feed tray 10 to the image formation means 36 one by one.

The second recording-material feed means 46 is operable to feed the recording materials P3, P4 on the double-side-printing intermediate tray 45 disposed in a double-side-printing feed passage 48, to the image formation means 36 one by one. The double-side-printing feed passage 48 is configured to allow the recording materials P3, P4 fed from the first recording-material feed means 9 to be color-printed by the image formation means 36 and then placed on the intermediate tray 45 in order of page number (in order P3, P4) and in a face-down manner. The recording materials P3, P4 placed on the intermediate tray 45 will be extracted by the second recording-material feed means 46 in order from the recording material having a larger page number.

The post-processing device 6 includes a post-processing section 38 for subjecting the color-printed recording materials P3, P4 to a post-processing such as stapling, and a first discharge section 41 for guiding the color-printed recording materials P3, P4 directly to a recording-material discharge tray 40. Specifically, the post-processing section 38 of the post-processing device 6 is operable to guide the recording materials P3, P4, which are color-printed by the image formation means 36 and then released from the first recording-material feed means 9 or the second recording-material feed means 46, to the post-processing tray 7 through the post-processing feed passage 42, so as to subject the recording materials P3, P4 on the post-processing tray 7 to the post processing, such as stapling or punching, and then discharge the post-processed recording materials P3, P4 from the post-processing tray 7 to the recording-material discharge tray 40. The first discharge section 41 of the post-processing device 6 is operable to receive the recording materials P3, P4 released from the first recording-material feed means 9 or the second recording-material feed means 46, and then guide the received recording materials P3, P4 to the recording-material discharge tray 40. The first discharge section 41 includes a feed mechanism such as feed rollers (not shown) disposed along its feed passage for the recording materials P3, P4. The post-processing tray 7 of the post-processing section 38 can be retractably pulled out from the main body of the post-processing device 6 to allow the recording materials P1, P2 monochrome-printed by the first image forming apparatus 3 to be placed thereon. The post-processing section 38 can serve as a second discharge section to discharge the recording materials P1, P2 from the post-processing tray 7 onto the recording-material discharge tray 40 without subjecting the recording materials P1, P2 on the post-processing tray 7 to the post-processing.

The recording materials P3, P4 fed from the first recording-material feed means 9 are color-printed by the image forming means 36, and then stacked on the double-side-printing intermediate tray 45 in order of page number (in order P3, P4) and in a face-down manner. Then, the recording materials fed from the intermediate tray 45 through the second recording-material feed means 46 is discharged by the first discharge section 41 of the post-processing device 6, and stacked on the recording-material discharge tray 40 in order of page number (in order P4, P3) and in a face-up manner. The above recording materials P1, P2 or the recording materials P1, P2 with monochrome images formed by the first image forming apparatus 3 are placed on the post-processing tray 7 in order of page number (in order of P1, P2) and in a face-up manner. Then, when the post-processing section 38 serves as the second discharge section, the recording materials P1, P2 on the post-processing tray 7 are discharged onto the record-material discharge tray 40 in a face-up manner. A conventional sensor (not shown) for detecting the placement of the recording materials is provided in each of the sheet-feed tray 10, the intermediate tray 45 and the post-processing tray 7.

The CPU 32 of the second image forming apparatus 4 is operable to check the page numbers of the job data transmitted from the computer 2, and switchingly operate either one of the second recording-material feed means 46/the first discharge section 41 and the post-processing section 38 serving as the second discharge section so that the page numbers of the recording materials to be stacked on the recording-material discharge tray 40 are serialized in a sequential order. More specifically, given that the monochrome pages P1, P2 and the color pages P3, P4 correspond to 1st/2nd pages and 3rd/4th pages, respectively, as shown in FIG. 6, the second recording-material feed means 46 and the first discharge section 41 are operated according to a control signal from the CPU 32, in such a manner that the 3rd and 4th pages or the recording material P3, P4 placed on the intermediate tray 45 in a face-down manner is fed in order of upper recording material (in order P4, P3), and then the first discharge section 41 discharges the recording materials P4, P4 on the recording-material discharge tray 40 in order P4, P3 and in a face-up manner. Then, the post-processing section 38 serving as the second discharge section is operated according to a control signal from the CPU 32 so as to sequentially discharge the 2nd page (P2) and 1st page (P1) of the monochrome pages from the post-processing tray 7 onto the recording-material discharge tray 40 in order of page number (in order P2, P1) and in a face-up manner.

The job-process-continuation-signal input means 37 includes input keys incorporated in an operation panel, a liquid-crystal display panel or the like. When the recording materials P1, P2 monochrome-printed by the first image forming apparatus 3 are placed on the post-processing tray 7 of the post-processing device 6, the aforementioned sensor (not shown) provided in the post-processing tray 7 detects the placement to enable the ON operation of the job-process-continuation-signal input means 37. If an ON signal is entered from the job-process-continuation-signal input means 37, the second image forming apparatus 4 is allowed to initiate the operation of discharging the recording materials on the intermediate tray 45 or the post-processing tray 7 onto the recording-material discharge tray 40 in order of page number.

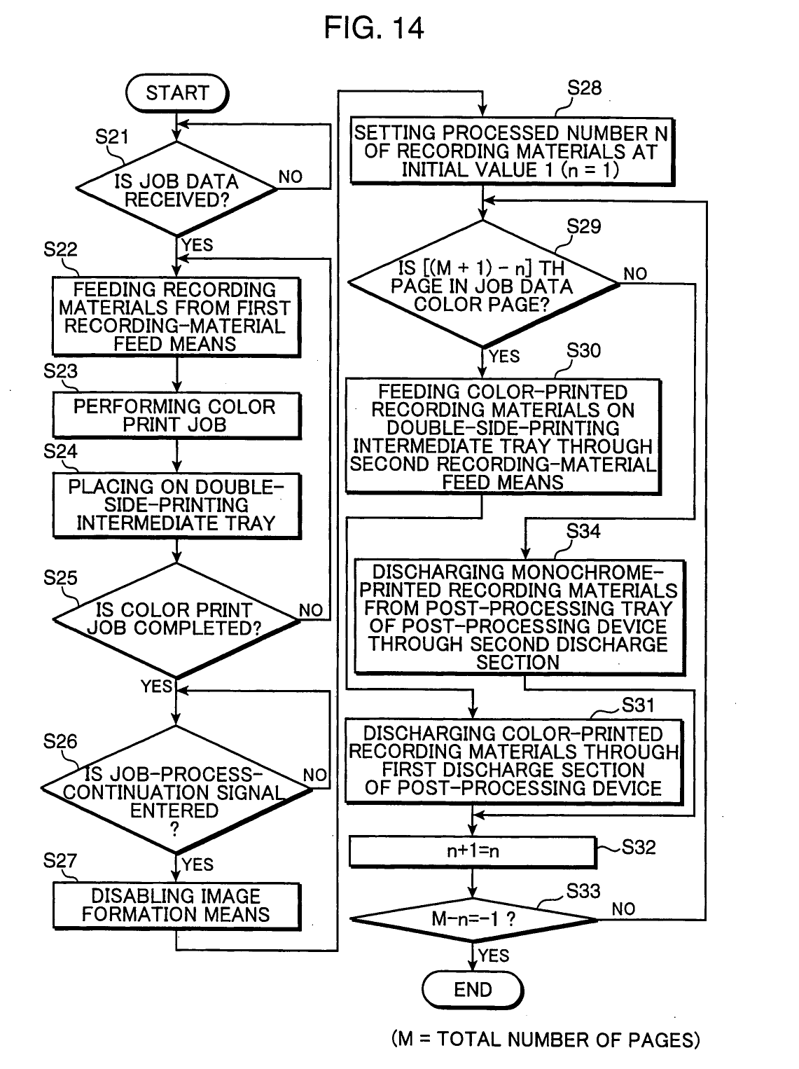

FIG. 14 is a flowchart showing the operation control of the second image forming apparatus 4 constructed as above. As shown in FIG. 14, when the second image forming apparatus 4 receives the job data transmitted from the computer 2 (Step S21), the recording materials P3, P4 are fed by the first recording-material feed means 9 (Step S22), and the color print job in the job data is performed by the image formation means 36 to form a color image on each of the recording materials P3, P4 (Step S23). Then, the color-printed recording materials P3, P4 are stacked on the double-side-printing intermediate tray 45 in order of page number (in order P3, P4) (Step S24).

After the completion of the entire color print job (Step S25), if the job-process-continuation signal is entered from the job-process-continuation signal input means 37 (Step S26), the operation of the image formation means 36 is disabled (Step S27), and the processed number n of recording materials is set at an initial value n=1 by the CPU 32 (Step S28). Then, the CPU 32 acts to check the page numbers of color print job data and the page numbers of the monochromatic print job data, and switchingly operates either one of the second recording-material feed means 46 and the post-processing section 38 serving as the second discharge section in descending order of page number (in order from a larger page number to a smaller page number) (Step S29). For example, given that the total number of pages to be printed in the job data is M, if a M-th page is determined as a color page (Step S29), the second recording-material feed means 46 feeds the color-printed recording material P4, P3 from the intermediate tray 45 (Step S30), and then the first discharge section 41 of the post-processing device 6 discharges these recording materials P4, P3 onto the recording-material discharge tray 40 in a face-up manner (Step S 31).

Then, the CPU adds one to the processed number n of recording materials (Step S32), and determines if the entire recording-materials have been processed (Step S33). If it is determined that the recording materials have not been completely processed (the entire recording materials on the intermediate tray 45 and the post-processing tray 7 have not been completely discharged onto the recording-material discharge tray 40), the process will return to Step S29 to perform the above processing. At Step S29, if the CPU 32 determines that the job data for the [(M+1)−n] th page indicates a monochrome page, the post-processing section 38 serving as the second discharge section will discharge the monochrome-printed recording materials P2, P1 from the post-processing tray 7 of the post-processing device 6 onto the recording-material discharge tray 40.

Then, if the CPU 32 determines that the entire recording materials have been processed (Step S33), the operation of mixing the recording materials together will be terminated. Through the above series of operations, the pages with only monochrome images and the pages with color images will be stacked on the recording-material discharge tray 40 in a face-up manner while being mixed together in order of page number (in order P4-P1).

(Effect of Third Embodiment)

As mentioned above, according to the third embodiment of the present invention, the monochromatic print job is performed in the first image forming apparatus 3, and the color print job is simultaneously performed in the second image forming apparatus 4. The monochrome-printed recording materials P1, P2 are set on the post-processing tray 7 of the post-processing device 6 in the second image forming apparatus 4, and the color-printed recording materials P3, P4 are stocked in the double-side-printing intermediate tray 45 in the second image forming apparatus 4. Then, according to the page numbers, either one of operations: one of feeding the recording materials P3, P4 on the intermediate tray 45 through the second recording-material feed means 46 and the first discharge section 41 of the post-processing device 6; another of feeding the recording materials P1, P2 on the post-processing tray 7 through the post-processing section 38 serving as the second discharge section, is selected to discharge the recording materials fed from the first discharge section 41 or the post-processing section (second discharge section) 38, onto the recording-material discharge tray 40. Thus, the recording materials with color and monochrome pages can be stacked on the recording-material discharge tray 40 while being mixed in order of page number (in order P4-P1). The image forming system 1 according to the third embodiment can eliminate the need for any dedicated machine, such as collator, for mixing monochrome-printed pages and color-printed pages together, to facilitate cost reduction in the image forming system 1.

In addition, the image forming system 1 according to the third embodiment allows monochromatic print data and color print data to be simultaneously processed. Thus, the processing time of print jobs can be desirably reduced as compared to a process of performing a color print job after the completion of a monochromatic print job.

[Other Embodiments]

In the aforementioned embodiments, in order to enable the operation of the job-process-continuation-signal

input means 37 only after confirming an identification number for identifying a user, a reference ID data may be appended in advance to job data to be transmitted from the computer 2 to the second image forming apparatus 4, so that it is checked whether the ID data entered from a ten-key, magnetic card or the like in the operation means 35 by a user is matched with the ID data appended to the job data.

While the first and second image forming apparatuses 3, 4 in the aforementioned embodiments have been configured as an image forming apparatus capable of performing only monochrome printing, and an image forming apparatus capable of performing color printing, respectively, the present invention is not limited thereto. For example, inversely, the first and second image forming apparatuses 3, 4 may be configured as an image forming apparatus capable of performing color printing and an image forming apparatus capable of performing only monochrome printing, respectively. Further, in the first embodiment, the first image forming apparatus 3 may be configured to perform the color print job in advance, and the second image forming apparatus 4 may be configured to mix color-printed recording materials and monochrome-printed recording materials together in order of page number while performing the monochromic print job therein.

While the computer 2 in the aforementioned embodiments has been configured to divide the print job data into two: the monochromatic print job data and the color print job data, the present invention is not limited thereto. For example, the computer 2 may be configured to divide the job data into three or more and transmit designated ones of divided data to a plurality (the same number as that of the division) of corresponding image forming apparatuses one of which is configured to perform the received print job and simultaneously mix recording materials with images obtained from this print job and other recording materials with images formed in the remaining image forming apparatuses, together in order of page number. In this case, the image forming apparatus handling the operation of mixing the recording materials together while performing print job is required to have recording-material feed means in the same number as that of divided print job data.

While the job date in the aforementioned embodiments has been divided into the monochromatic print job data and the color print job data, the present invention is not limited thereto. For example, the job data may be divided in accordance a specific condition or rule such as whether each of pages includes graphic data.

Further, in the image forming system 1 according to each of the aforementioned embodiments, the computer 2 may be incorporated in the image forming apparatus.

Furthermore, while the image forming apparatus in the aforementioned embodiments has been described as an electrophotographic type, the present invention is not limited thereto, but any other suitable image forming means such as an inkjet type may be used.

In general, routines executed to implement above-described embodiments of the present invention, whether implemented as part of an operating system or a specific application, component, program, object, module or sequence of instructions will be referred to herein as “programs.” The programs typically compose one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, a floppy disc (registered trademark) and other removable disks, hard disk drives, optical disks (e.g., CD-ROM's, DVD's, etc.), among others, and transmission type media such as digital and analog communication links, including the Internet.

As described above, an image forming system comprises a computer, a first image forming apparatus capable of performing only monochrome printing, and a second image forming apparatus capable of performing color printing, which are connected with each other via a network. The computer has (a) a page-number appending function of appending page numbers onto job data, (b) a job-data dividing function of dividing the job data into monochromatic print data and color print data, (c) a job-data allocating function of allocating the monochromatic print job data and color print job data divided through the job-data dividing function, respectively, to the first image forming apparatus and the second image forming apparatus, and (d) a data-transmitting/receiving function of transmitting the monochromatic print job data to the first image forming apparatus via the network, and transmitting the color print job data to the second image forming apparatus via the network in response to the reception of a job-process-continuation signal from the second image forming apparatus after receiving a job-completion signal from the first image forming apparatus. The first image forming apparatus includes (a) first image formation means for forming a monochrome image on each of first recording materials in accordance with the monochromatic print job data transmitted from the computer, (b) job-completion detection means for detecting completion of the monochromatic print job and then outputting the job-completion signal to the computer, and (c) first communication means for allowing data communication with the computer via the network. The second image forming apparatus includes (a) second image formation means for forming a color image on each of second recording materials in order of page number in accordance with the color print job data transmitted from the computer, (b) recording-material feed means for feeding the second recording materials to the second image formation means, (c) a post-processing device having a post-processing section with a post-processing tray, and a first discharge section, wherein the post-processing section is adapted to guide the second recording materials fed from the recording-material feed means and color-printed by the second image formation means, to the post-processing tray, so as to subject the second recording materials on the post-processing tray to a post-processing and then discharge the second recording materials from the post-processing tray onto a recording-material discharge tray, and the first discharge section is adapted to discharge the second recording materials fed from the recording-material feed means and color-printed by the second image formation means, directly onto the recording-material discharge tray, (d) job-process-continuation-signal input means for entering the job-process-continuation signal therethrough, wherein the job-process-continuation-signal input means is adapted to allow the job-process-continuation signal to be output to the computer only after the first recording materials with monochrome images formed by the first image forming apparatus are set on the post-processing tray of the post-processing device, (e) second communication means for allowing data communication with the computer via the network, and (f) image-formation control means for controlling respective operations of the second image formation means, the recording-material feed means, the post-processing device, the job-process-continuation-signal input means and the second communication means. The image-formation control means has (1) a function of switching an operation of the post-processing device in such a manner that in response to the job-process-continuation signal entered from the job-process-continuation-signal input means, the second recording materials color-printed by the second image formation means are discharged directly onto the recording-material discharge tray through the first discharge section, and the post-processing section serves as a second discharge section to discharge the first recording materials set on the post-processing tray, onto the recording-material discharge tray without subjecting the first recording materials set on the post-processing tray to the post-processing, and (2) a recording-material mixing function of checking the page numbers of the color print job data transmitted from the computer, and switching respective operations of the recording-material feed means and the post-processing means to allow color pages and monochrome pages to be mixed together while serializing their page numbers in a sequential order.

Also, there is provided an image forming system comprising a plurality of image forming apparatuses and a computer, which are connected with each other via a network, wherein each of the image forming apparatuses is adapted to be operated in accordance with job data from the computer. The computer has (a) a page-number appending function of appending page numbers onto the job data, (b) a job-data dividing function of dividing the job data in accordance with a given dividing rule, (c) a job-data allocating function of allocating the plural job data divided through the job-data dividing function, respectively, to the specified image forming apparatuses, and (d) a data-transmitting/receiving function of transmitting the plural job data allocated through the job-data allocating function, to the corresponding image forming apparatuses via the network. At least one of the image forming apparatuses includes (a) image formation means for forming an image on each of first recording materials in order of page number in accordance with the job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and formed with images, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from the recording-material feed means and formed with images, directly onto the recording-material discharge tray, (d) job-process-continuation-signal input means for entering a job-process-continuation signal therethrough, wherein the job-process-continuation-signal input means is adapted to allow the job-process-continuation signal to be output to the computer only after second recording materials with images formed by another one of the image forming apparatuses are set on the post-processing tray of the post-processing device, (e) communication means for allowing data communication with the computer via the network, and (f) image-formation control means for controlling respective operations of the image formation means, the recording-material feed means, the post-processing device, the job-process-continuation-signal input means and the communication means. The image-formation control means has (1) a function of switching an operation of the post-processing device in such a manner that in response to the job-process-continuation signal entered from the job-process-continuation-signal input means, the first recording materials with images formed by the image formation means are discharged directly onto the recording-material discharge tray through the first discharge section, and the post-processing section serves as a second discharge section to discharge the second recording materials from the post-processing tray onto the recording-material discharge tray without subjecting the second recording materials set on the post-processing tray to the post-processing, and (2) a recording-material mixing function of checking the page numbers of the job data transmitted from the computer, and switching the respective operations of the recording-material feed means and the post-processing device to allow the second recording materials with images formed by the another image forming apparatus and the first recording materials with images formed by the image formation means to be mixed together while serializing their page numbers in a sequential order.

There is provided an image forming system comprising a plurality of image forming apparatuses and a computer, which are connected with each other via a network, wherein each of the image forming apparatuses is adapted to be operated in accordance with job data from the computer. The computer has (a) a page-number appending function of appending page numbers onto the job data, (b) a job-data dividing function of dividing the job data in accordance with a given dividing rule, (c) a job-data allocating function of allocating the plural job data divided through the job-data dividing function, respectively, to the specified image forming apparatuses, and (d) a data-transmitting/receiving function of transmitting the plural job data allocated through the job-data allocating function, to the corresponding image forming apparatuses via the network. At least one of the plurality of image forming apparatuses includes (a) image formation means for forming an image on each of first recording materials in order of page number in accordance with the job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials on the double-side-printing intermediate tray to the image formation means, (d) a third recording-material feed means having a recording-material receiving section for placing thereon second recording materials with images formed by another one of the image forming apparatuses in order of page number, wherein the third recording-material feed means is adapted to feed the second recording materials placed on the recording-material receiving section to the image formation means, (e) job-process-continuation-signal input means for entering a signal for initiating to feed the first and second recording materials through the second and third recording-material feed means, respectively, wherein the job-process-continuation-signal input means is adapted to allow the signal to be entered therethrough only after the second recording materials are set on the recording-material receiving section of the third recording-material feed means, (f) recording-material discharge means for discharging the first and second recording materials fed from the second and third recording-material feed means, onto a recording-material discharge tray, (g) communication means for allowing data communication with the computer via the network, and (h) image-formation control means for controlling respective operations of the image formation means, the first to third recording-material feed means, the job-process-continuation-signal input means, the recording-material discharge means and the communication means. The image-formation control means has (1) a printing ON/OFF function of operating the image formation means to form images on the first recording materials during the feeding of the first recording materials through the first recording-material feed means, and disabling the printing operation of the image formation means in response to the signal entered from the job-process-continuation signal input means, and (2) a function of checking the page numbers of the job data transmitted from the computer, and switching respective operations of the second recording-material feed means and the third recording-material feed means to allow the second recording materials with images formed by the another image forming apparatus and the first recording materials with images formed by the image formation means to be mixed together while serializing their page numbers in a sequential order.

There is provided an image forming system comprising a plurality of image forming apparatuses and a computer, which are connected with each other via a network, wherein each of the image forming apparatuses is adapted to be operated in accordance with job data from the computer. The computer has (a) a page-number appending function of appending page numbers onto the job data, (b) a job-data dividing function of dividing the job data in accordance with a given dividing rule, (c) a job-data allocating function of allocating the plural job data divided through the job-data dividing function, respectively, to the specified image forming apparatuses, and (d) a data-transmitting/receiving function of transmitting the plural job data allocated through the job-data allocating function, to the corresponding image forming apparatuses via the network. At least one of the plurality of image forming apparatuses includes (a) image formation means for forming an image on each of first recording materials in order of page number in accordance with the job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials from the double-side-printing intermediate tray to the image formation means, (d) a post-processing device having a post-processing section with a post-processing tray, and a first discharge section, wherein the post-processing section is adapted to guide the first recording materials fed from either one of the first and second recording-material feed means and formed with images, onto the post processing tray so as to subject the first recording materials on the post-processing tray to a post-processing and then discharge the first recording materials from the post-processing tray onto a recording-material discharge tray, and the first discharge section is adapted to discharge the first recording materials fed from either one of the first and second recording-material feed means and formed with images, directly onto the recording-material discharge tray, (e) job-process-continuation-signal input means for entering a signal for initiating an operation of mixing the first recording materials fed through the second recording-material feed means, and second recording materials with images formed by another one of the image forming apparatuses, wherein the job-process-continuation-signal input means is adapted to allow the signal to be entered therethrough only after the second recording materials are set on the post-processing tray of the post-processing device, (f) communication means for allowing data communication with the computer via the network, and (g) image-formation control means for controlling respective operations of the image formation means, the first and second recording-material feed means, the post-processing device, the job-process-continuation-signal input means, and the communication means. The image-formation control means has (1) a printing ON/OFF function of operating the image formation means to form images on the first recording materials during the feeding of the first recording materials through the first recording-material feed means without the signal to be entered from the job-process-continuation-signal input means, and disabling the printing operation of the image formation means in response to the signal entered from the job-process-continuation signal input means, (2) a function of switching an operation of the post-processing device in such a manner that when the signal is entered from the job-process-continuation-signal input means, and the first recording materials are fed through the second recording-material feed means, the first recording materials fed from the second recording-material feed means are discharged directly onto the recording-material discharge tray through the first discharge section, and the post-processing section serves as a second discharge section to discharge the second recording materials from the post-processing tray onto the recording-material discharge tray without subjecting the second recording materials placed on the post-processing tray to the post-processing, and (3) a recording-material mixing function of checking the page numbers of the job data transmitted from the computer, and switching respective operations of the second recording-material feed means and the post-processing section to allow the second recording materials with images formed by the another image forming apparatus and the first recording materials with images formed by the image formation means to be mixed together while serializing their page numbers in a sequential order.

There is provided an image forming apparatus capable of performing color printing, wherein the image forming apparatus is connected to a computer via a network together with another image forming apparatus capable of performing only monochrome printing. The image forming apparatus includes (a) image formation means for forming a color image on each of first recording materials in order of page number in accordance with color print job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and color-printed by the image formation means, to the post-processing tray, so as to subject the first recording materials on the post-processing tray to a post-processing and then discharge the first recording materials from the post-processing tray onto a recording-material discharge tray, and the first discharge section is adapted to discharge the recording materials fed from the recording-material feed means and color-printed by the image formation means, directly onto the recording-material discharge tray, (d) job-process-continuation-signal input means for entering the job-process-continuation signal therethrough, wherein the job-process-continuation-signal input means is adapted to allow the job-process-continuation signal to be output to the computer only after second recording materials with monochrome images formed by the another image forming apparatus are set on the post-processing tray of the post-processing device, (e) communication means for allowing data communication with the computer via the network, and (f) image-formation control means for controlling respective operations of the image formation means, the recording-material feed means, the post-processing device, the job-process-continuation-signal input means and the communication means. The image-formation control means has (1) a function of switching an operation of the post-processing device in such a manner that in response to the job-process-continuation signal entered from the job-process-continuation-signal input means, the first recording materials color-printed by the image formation means are discharged directly onto the recording-material discharge tray through the first discharge section, and the post-processing section serves as a second discharge section to discharge the second recording materials set on the post-processing tray onto the recording-material discharge tray without subjecting the second recording materials set on the post-processing tray to the post-processing, and (2) a recording-material mixing function of checking the page numbers of the color print job data transmitted from the computer, and switching respective operations of the recording-material feed means and the post-processing means to allow color pages and monochrome pages to be mixed together while serializing their page numbers in a sequential order.

There is provided an image forming apparatus connected to a computer via a network together with another image forming apparatuses. The image forming apparatus includes (a) image formation means for forming an image on each of first recording materials in order of page number in accordance with job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and formed with images, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from the recording-material feed means and formed with images, directly onto the recording-material discharge tray, (d) job-process-continuation-signal input means for entering a job-process-continuation signal therethrough, wherein the job-process-continuation-signal input means is adapted to allow the job-process-continuation signal to be output to the computer only after second recording materials with images formed by the another image forming apparatus are set on the post-processing tray of the post-processing device, (e) communication means for allowing data communication with the computer via the network, and (f) image-formation control means for controlling respective operations of the image formation means, the recording-material feed means, the post-processing device, the job-process-continuation-signal input means and the communication means. The image-formation control means has (1) a function of switching an operation of the post-processing device in such a manner that in response to the job-process-continuation signal entered from the job-process-continuation-signal input means, the first recording materials with images formed by the image formation means are discharged directly onto the recording-material discharge tray through the first discharge section, and the post-processing section serves as a second discharge section to discharge the second recording materials from the post-processing tray onto the recording-material discharge tray without subjecting the second recording materials set on the post-processing tray to the post-processing, and (2) a recording-material mixing function of checking the page numbers of the job data transmitted from the computer, and switching respective operations of the recording-material feed means and the post-processing device to allow the second recording materials with images formed by the another image forming apparatus and the first recording materials with images formed by the image formation means to be mixed together while serializing their page numbers in a sequential order.

There is provided an image forming apparatus connected to a computer via a network together with another image forming apparatuses. The image forming apparatus includes (a) image formation means for forming an image on each of first recording materials in order of page number in accordance with job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials on the double-side-printing intermediate tray to the image formation means, (d) a third recording-material feed means having a recording-material receiving section for placing thereon second recording materials with images formed by the another image forming apparatus in order of page number, wherein the third recording-material feed means is adapted to feed the second recording materials placed on the recording-material receiving section to the image formation means, (e) job-process-continuation-signal input means for entering a signal for initiating to feed the first and second recording materials through the second and third recording-material feed means, respectively, wherein the job-process-continuation-signal input means is adapted to allow the signal to be entered therethrough only after the second recording materials are set on the recording-material receiving section of the third recording-material feed means, (f) recording-material discharge means for discharging the first and second recording materials fed from the second and third recording-material feed means, onto a recording-material discharge tray, (g) communication means for allowing data communication with the computer via the network, and (h) image-formation control means for controlling respective operations of the image formation means, the first to third recording-material feed means, the job-process-continuation-signal input means, the recording-material discharge means and the communication means. The image-formation control means has (1) a printing ON/OFF function of operating the image formation means to form images on the first recording materials during the feeding of the first recording materials through the first recording-material feed means, and disabling the printing operation of the image formation means in response to the signal entered from the job-process-continuation signal input means, and (2) a function of checking page numbers of the job data transmitted from the computer, and switching respective operations of the second recording-material feed means and the third recording-material feed means to allow the second recording materials with images formed by the another image forming apparatus and the first recording materials with images formed by the image formation means to be mixed together while serializing their page numbers in a sequential order.

There is provided an image forming apparatus connected to a computer via a network together with another image forming apparatuses. The image forming apparatus includes (a) image formation means for forming an image on each of first recording materials in order of page number in accordance with the job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials from the double-side-printing intermediate tray to the image formation means, (d) a post-processing device having a post-processing section with a post-processing tray, and a first discharge section, wherein the post-processing section is adapted to guide the first recording materials fed from either one of the first and second recording-material feed means and formed with images, onto the post processing tray, so as to subject the first recording materials on the post-processing tray to a post-processing and then discharge the first recording materials from the post-processing tray onto a recording-material discharge tray, and the first discharge section is adapted to discharge the first recording materials fed from either one of the first and second recording-material feed means and formed with images, directly onto the recording-material discharge tray, (e) job-process-continuation-signal input means for entering a signal for initiating an operation of mixing the first recording materials fed through the second recording-material feed means, and second recording materials with images formed by another one of the image forming apparatuses, wherein the job-process-continuation-signal input means is adapted to allow the signal to be entered therethrough only after the second recording materials are set on the post-processing tray of the post-processing device, (f) communication means for allowing data communication with the computer via the network, and (g) image-formation control means for controlling respective operations of the image formation means, the first and second recording-material feed means, the post-processing device, the job-process-continuation-signal input means, and the communication means. The image-formation control means has (1) a printing ON/OFF function of operating the image formation means to form images on the first recording materials during the feeding of the first recording materials through the first recording-material feed means without the signal to be entered from the job-process-continuation-signal input means, and disabling a printing operation of the image formation means in response to the signal entered from the job-process-continuation signal input means, (2) a function of switching an operation of the post-processing device in such a manner that when the signal is entered from the job-process-continuation-signal input means, and the first recording materials are fed through the second recording-material feed means, the first recording materials fed from the second recording-material feed means are discharged directly onto the recording-material discharge tray through the first discharge section, and the post-processing section serves as a second discharge section to discharge the second recording materials from the post-processing tray onto the recording-material discharge tray without subjecting the second recording materials placed on the post-processing tray to the post-processing, and (3) a recording-material mixing function of checking page numbers of the job data transmitted from the computer, and switching respective operations of the second recording-material feed means and the post-processing section to allow the second recording materials with images formed by the another image forming apparatus and the first recording materials with images formed by the image formation means to be mixed together while serializing their page numbers in a sequential order.

There is provided an operation control method for an image forming apparatus capable of performing color printing, wherein the image forming apparatus is connected to a computer via a network together with another image forming apparatus capable of performing only monochrome printing, and provided with (a) image formation means for forming a color image on each of first recording materials in order of page number in accordance with color print job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and color-printed by the image formation means, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from recording-material feed means and color-printed by the image formation means, directly onto the recording-material discharge tray, (d) job-process-continuation-signal input means for entering the job-process-continuation signal therethrough, wherein the job-process-continuation-signal input means is adapted to allow the job-process-continuation signal to be output to the computer only after second recording materials with monochrome images formed by the another image forming apparatus are set on the post-processing tray of the post-processing device, (e) communication means for allowing data communication with the computer via the network, and (f) image-formation control means for controlling respective operations of the image formation means, the recording-material feed means, the post-processing device, the job-process-continuation-signal input means and the communication means. The operation control method comprises operating the image-formation control means to perform (1) a function of switching an operation of the post-processing device in such a manner that in response to the job-process-continuation signal entered from the job-process-continuation-signal input means, the first recording materials color-printed by the image formation means are discharged directly onto the recording-material discharge tray through the first discharge section, and the post-processing section serves as a second discharge section to discharge the second recording materials set on the post-processing tray onto the recording-material discharge tray without subjecting the second recording materials set on the post-processing tray to the post-processing, and (2) a recording-material mixing function of checking the page numbers of the color print job data transmitted from the computer, and switching respective operations of the recording-material feed means and the post-processing means to allow color pages and monochrome pages to be mixed together while serializing their page numbers in a sequential order.

There is provided an operation control method for an image forming apparatus connected to a computer via a network together with another image forming apparatuses, wherein the image forming apparatus includes (a) image formation means for forming an image on each of first recording materials in order of page number in accordance with job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and formed with images, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from the recording-material feed means and formed with images, directly onto the recording-material discharge tray, (d) job-process-continuation-signal input means for entering a job-process-continuation signal therethrough, wherein the job-process-continuation-signal input means is adapted to allow the job-process-continuation signal to be output to the computer only after second recording materials with images formed by the another image forming apparatus are set on the post-processing tray of the post-processing device, (e) communication means for allowing data communication with the computer via the network, and (f) image-formation control means for controlling the respective operations of the image formation means, the recording-material feed means, the post-processing device, the job-process-continuation-signal input means and the communication means. The operation control method comprises operating the image-formation control means to perform (1) a function of switching an operation of the post-processing device in such a manner that in response to the job-process-continuation signal entered from the job-process-continuation-signal input means, the first recording materials with images formed by the image formation means are discharged directly onto the recording-material discharge tray through the first discharge section, and the post-processing section serves as a second discharge section to discharge the second recording materials from the post-processing tray onto the recording-material discharge tray without subjecting the second recording materials set on the post-processing tray to the post-processing, and (2) a recording-material mixing function of checking the page numbers of the job data transmitted from the computer, and switching respective operations of the recording-material feed means and the post-processing device to allow the second recording materials with images formed by the another image forming apparatus and the first recording materials with images formed by the image formation means to be mixed together while serializing their page numbers in a sequential order.

There is provided an operation control method for an image forming apparatus connected to a computer via a network together with another image forming apparatuses, wherein the image forming apparatus includes (a) image formation means for forming an image on each of first recording materials in order of page number in accordance with job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials on the double-side-printing intermediate tray to the image formation means, (d) a third recording-material feed means having a recording-material receiving section for placing thereon second recording materials with images formed by the another image forming apparatus in order of page number, wherein the third recording-material feed means is adapted to feed the second recording materials placed on the recording-material receiving section to the image formation means, (e) job-process-continuation-signal input means for entering a signal for initiating to feed the first and second recording materials through the second and third recording-material feed means, respectively, wherein the job-process-continuation-signal input means is adapted to allow the signal to be entered therethrough only after the second recording materials are set on the recording-material receiving section of the third recording-material feed means, (f) recording-material discharge means for discharging the first and second recording materials fed from the second and third recording-material feed means, onto a recording-material discharge tray, (g) communication means for allowing data communication with the computer via the network, and (h) image-formation control means for controlling respective operations of the image formation means, the first to third recording-material feed means, the job-process-continuation-signal input means, the recording-material discharge means and the communication means. The operation control method comprises operating the image-formation control means to perform (1) a printing ON/OFF function of operating the image formation means to form images on the first recording materials during the feeding of the first recording materials through the first recording-material feed means, and disabling the printing operation of the image formation means in response to the signal entered from the job-process-continuation signal input means, and (2) a function of checking page numbers of the job data transmitted from the computer, and switching respective operations of the second recording-material feed means and the third recording-material feed means to allow the second recording materials with images formed by the another image forming apparatus and the first recording materials with images formed by the image formation means to be mixed together while serializing their page numbers in a sequential order.

There is provided an operation control method for an image forming apparatus connected to a computer via a network together with another image forming apparatuses, wherein the image forming apparatus includes (a) image formation means for forming an image on each of first recording materials in order of page number in accordance with the job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials from the double-side-printing intermediate tray to the image formation means, (d) a post-processing device having a post-processing section with a post-processing tray, and a first discharge section, wherein the post-processing section is adapted to guide the first recording materials fed from either one of the first and second recording-material feed means and formed with images, onto the post processing tray, so as to subject the first recording materials on the post-processing tray to a post-processing and then discharge the first recording materials from the post-processing tray onto a recording-material discharge tray, and the first discharge section is adapted to discharge the first recording materials fed from either one of the first and second recording-material feed means and formed with images, directly onto the recording-material discharge tray, (e) job-process-continuation-signal input means for entering a signal for initiating an operation of mixing the first recording materials fed through the second recording-material feed means, and second recording materials with images formed by another one of the image forming apparatuses, wherein the job-process-continuation-signal input means is adapted to allow the signal to be entered therethrough only after the second recording materials are set on the post-processing tray of the post-processing device, (f) communication means for allowing data communication with the computer via the network, and (g) image-formation control means for controlling respective operations of the image formation means, the first and second recording-material feed means, the post-processing device, the job-process-continuation-signal input means, and the communication means. The operation control method comprises operating the image-formation control means to perform (1) a printing ON/OFF function of operating the image formation means to form images on the first recording materials during feeding of the first recording materials through the first recording-material feed means without the signal to be entered from the job-process-continuation-signal input means, and disabling a printing operation of the image formation means in response to the signal entered from the job-process-continuation signal input means, (2) a function of switching an operation of the post-processing device in such a manner that when the signal is entered from the job-process-continuation-signal input means, and the first recording materials are fed through the second recording-material feed means, the first recording materials fed from the second recording-material feed means are discharged directly onto the recording-material discharge tray through the first discharge section, and the post-processing section serves as a second discharge section to discharge the second recording materials from the post-processing tray onto the recording-material discharge tray without subjecting the second recording materials placed on the post-processing tray to the post-processing, and (3) a recording-material mixing function of checking page numbers of the job data transmitted from the computer, and switching respective operations of the second recording-material feed means and the post-processing section to allow the second recording materials with images formed by the another image forming apparatus and the first recording materials with images formed by the image formation means to be mixed together while serializing their page numbers in a sequential order.

There is provided a program product for verifying an operational status of a computer comprising: (A) a control program for an image forming apparatus capable of performing color printing, wherein the image forming apparatus is connected to a computer via a network together with another image forming apparatus capable of performing only monochrome printing, and provided with (a) image formation means for forming a color image on each of first recording materials in order of page number in accordance with color print job data transmitted from the computer, (b) recording-material feed means for feeding the first recording materials to the image formation means, (c) a post-processing device having a post-processing section with a post-processing tray, and a first discharge section, wherein the post-processing section is adapted to guide the recording materials fed from the recording-material feed means and color-printed by the image formation means, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from the recording-material feed means and color-printed by the image formation means, directly onto the recording-material discharge tray, (d) job-process-continuation-signal input means for entering the job-process-continuation signal therethrough, wherein the job-process-continuation-signal input means is adapted to allow the job-process-continuation signal to be output to the computer only after second recording materials with monochrome images formed by the another image forming apparatus are set on the post-processing tray of the post-processing device, (e) communication means for allowing data communication with the computer via the network, and (f) image-formation control means for controlling respective operations of the image formation means, the recording-material feed means, the post-processing means, the job-process-continuation-signal input means and the communication means. The control program comprises sequence of instructions to be executed within the image forming apparatus so as to allow the image-formation control means to perform (1) a function of switching an operation of the post-processing device in such a manner that in response to the job-process-continuation signal entered from the job-process-continuation-signal input means, the first recording materials color-printed by the image formation means are discharged directly onto the recording-material discharge tray through the first discharge section, and the post-processing section serves as a second discharge section to discharge the second recording materials set on the post-processing tray onto the recording-material discharge tray without subjecting the second recording materials set on the post-processing tray to the post-processing, and (2) a recording-material mixing function of checking the page numbers of the color print job data transmitted from the computer, and switching respective operations of the recording-material feed means and the post-processing means to allow color pages and monochrome pages to be mixed together while serializing their page numbers in a sequential order, and (B) a signal bearing media bearing said control program.

There is provided a program product for verifying an operational status of a computer comprising: (A) a control program for an image forming apparatus connected to a computer via a network together with another image forming apparatuses, wherein the image forming apparatus includes (a) image formation means for forming an image on each of first recording materials in order of page number in accordance with job data transmitted from the computer, (b) recording-material feed means for feeding the first recording materials to the image formation means, (c) a post-processing device having a post-processing section with a post-processing tray, and a first discharge section, wherein the post-processing section is adapted to guide the first recording materials fed from the recording-material feed means and formed with images, to the post-processing tray, so as to subject the first recording materials on the post-processing tray to a post-processing and then discharge the first recording materials from the post-processing tray onto a recording-material discharge tray, and the first discharge section is adapted to discharge the first recording materials fed from the recording-material feed means and formed with images, directly onto the recording-material discharge tray, (d) job-process-continuation-signal input means for entering a job-process-continuation signal therethrough, wherein the job-process-continuation-signal input means is adapted to allow the job-process-continuation signal to be output to the computer only after second recording materials with images formed by the another image forming apparatus are set on the post-processing tray of the post-processing device, (e) communication means for allowing data communication with the computer via the network, and (f) image-formation control means for controlling the respective operations of the image formation means, the recording-material feed means, the post-processing device, the job-process-continuation-signal input means and the communication means. The control program comprises sequence of instructions to be executed within the image forming apparatus so as to allow the image-formation control means to perform (1) a function of switching an operation of the post-processing device in such a manner that in response to the job-process-continuation signal entered from the job-process-continuation-signal input means, the first recording materials with images formed by the image formation means are discharged directly onto the recording-material discharge tray through the first discharge section, and the post-processing section serves as a second discharge section to discharge the second recording materials from the post-processing tray onto the recording-material discharge tray without subjecting the second recording materials set on the post-processing tray to the post-processing, and (2) a recording-material mixing function of checking page numbers of the job data transmitted from the computer, and switching respective operations of the recording-material feed means and the post-processing device to allow the second recording materials with images formed by the another image forming apparatus and the first recording materials with images formed by the image formation means to be mixed together while serializing their page numbers in a sequential order, and (B) a signal bearing media bearing said control program.

There is provided a program product for verifying an operational status of a computer comprising: (A) a control program for an image forming apparatus connected to a computer via a network together with another image forming apparatuses, wherein the image forming apparatus includes (a) image formation means for forming an image on each of first recording materials in order of page number in accordance with job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials on the double-side-printing intermediate tray to the image formation means, (d) a third recording-material feed means having a recording-material receiving section for placing thereon second recording materials with images formed by the another image forming apparatus in order of page number, wherein the third recording-material feed means is adapted to feed the second recording materials placed on the recording-material receiving section to the image formation means, (e) job-process-continuation-signal input means for entering a signal for initiating to feed the first and second recording materials through the second and third recording-material feed means, respectively, wherein the job-process-continuation-signal input means is adapted to allow the signal to be entered therethrough only after the second recording materials are set on the recording-material receiving section of the third recording-material feed means, (f) recording-material discharge means for discharging the first and second recording materials fed from the second and third recording-material feed means, onto a recording-material discharge tray, (g) communication means for allowing data communication with the computer via the network, and (h) image-formation control means for controlling respective operations of the image formation means, the first to third recording-material feed means, the job-process-continuation-signal input means, the recording-material discharge means and the communication means. The control program comprises sequence of instructions to be executed within the image forming apparatus so as to allow the image-formation control means to perform (1) a printing ON/OFF function of operating the image formation means to form images on the first recording materials during feeding of the first recording materials through the first recording-material feed means, and disabling printing operation of the image formation means in response to the signal entered from the job-process-continuation signal input means, and (2) a function of checking page numbers of the job data transmitted from the computer, and switching respective operations of the second recording-material feed means and the third recording-material feed means to allow the second recording materials with images formed by the another image forming apparatus and the first recording materials with images formed by the image formation means to be mixed together while serializing their page numbers in a sequential order, and (B) a signal bearing media bearing said control program.

There is provided a program product for verifying an operational status of a computer comprising: (A) a control program for an image forming apparatus connected to a computer via a network together with another image forming apparatuses, wherein the image forming apparatus includes (a) image formation means for forming an image on each of first recording materials in order of page number in accordance with job data transmitted from the computer, (b) a first recording-material feed means for feeding the first recording materials to the image formation means, (c) a second recording-material feed means having a double-side-printing intermediate tray, wherein the second recording-material feed means is adapted to place the first recording materials fed from the first recording-material feed means and formed with images, onto the double-side-printing intermediate tray, and then feed the first recording materials from the double-side-printing intermediate tray to the image formation means, (d) a post-processing device having a post-processing section with a post-processing tray, and a first discharge section, wherein the post-processing section is adapted to guide the first recording materials fed from either one of the first and second recording-material feed means and formed with images, onto the post processing tray, so as to subject the first recording materials on the post-processing tray to a post-processing and then discharge the first recording materials from the post-processing tray onto a recording-material discharge tray, and the first discharge section is adapted to discharge the first recording materials fed from either one of the first and second recording-material feed means and formed with images, directly onto the recording-material discharge tray, (e) job-process-continuation-signal input means for entering a signal for initiating an operation of mixing the first recording materials fed through the second recording-material feed means, and second recording materials with images formed by another one of the image forming apparatuses, wherein the job-process-continuation-signal input means is adapted to allow the signal to be entered therethrough only after the second recording materials are set on the post-processing tray of the post-processing device, (f) communication means for allowing data communication with the computer via the network, and (g) image-formation control means for controlling respective operations of the image formation means, the first and second recording-material feed means, the post-processing device, the job-process-continuation-signal input means, and the communication means. The control program comprises sequence of instructions to be executed within the image forming apparatus so as to allow the image-formation control means to perform (1) a printing ON/OFF function of operating the image formation means to form images on the first recording materials during feeding of the first recording materials through the first recording-material feed means without the signal to be entered from the job-process-continuation-signal input means, and disabling a printing operation of the image formation means in response to the signal entered from the job-process-continuation signal input means, (2) a function of switching an operation of the post-processing device in such a manner that when the signal is entered from the job-process-continuation-signal input means, and the first recording materials are fed through the second recording-material feed means, the first recording materials fed from the second recording-material feed means are discharged directly onto the recording-material discharge tray through the first discharge section, and the post-processing section serves as a second discharge section to discharge the second recording materials from the post-processing tray onto the recording-material discharge tray without subjecting the second recording materials placed on the post-processing tray to the post-processing, and (3) a recording-material mixing function of checking page numbers of the job data transmitted from the computer, and switching respective operations of the second recording-material feed means and the post-processing section to allow the second recording materials with images formed by the another image forming apparatus and the first recording materials with images formed by the image formation means to be mixed together while serializing their page numbers in a sequential order, and (B) a signal bearing media bearing said control program.

There is provided the program product of any one of thirteenth to sixteenth aspects of the present invention, wherein said signal bearing media comprises at least one of a transmission-type media and a recordable media.

Even if job data includes monochromatic print data and color print data in combination, a desired print job can be accomplished without any dedicated machine such as a collator for mixing monochrome-printed pages and color-printed pages together. Thus, the present invention allows an image forming system to be simplified in structure and reduced in cost.

This application is based upon Japanese Patent Application No. 2002-200936, filed Jul. 10, 2002, the entire contents of which are incorporated herein by reference.

While the invention has been shown and described in detail, the foregoing description is in all aspects illustrative and not restrictive. It is therefore understood that numerous modification and variations can be devised without departing from the scope of the invention.

1. An image forming system, comprising a computer, a first image forming apparatus capable of performing only monochrome printing, and a second image forming apparatus capable of performing color printing, which are connected with each other via a network, wherein
said computer has:
(a) a page-number appending function of appending page numbers onto job data,
(b) a job-data dividing function of dividing said job data into monochromatic print data and color print data,
(c) a job-data allocating function of allocating said monochromatic print job data and color print job data divided through said job-data dividing function, respectively, to said first image forming apparatus and said second image forming apparatus, and
(d) a data-transmitting/receiving function of transmitting said monochromatic print job data to said first image forming apparatus via said network, and transmitting said color print job data to said second image forming apparatus via said network in response to reception of a job-process-continuation signal from said second image forming apparatus after receiving a job-completion signal from said first image forming apparatus,
said first image forming apparatus includes:
(a) first image formation means for forming a monochrome image on each of first recording materials in accordance with said monochromatic print job data transmitted from said computer,
(b) job-completion detection means for detecting completion of said monochromatic print job and then outputting said job-completion signal to said computer, and
(c) first communication means for allowing data communication with said computer via said network,
said second image forming apparatus includes:
(a) second image formation means for forming a color image on each of second recording materials in order of page number in accordance with said color print job data transmitted from said computer,
(b) recording-material feed means for feeding said second recording materials to said second image formation means,
(c) a post-processing device having a post-processing section with a post-processing tray, and a first discharge section, wherein said post-processing section is adapted to guide said second recording materials fed from said recording-material feed means and color-printed by said second image formation means, to said post-processing tray, so as to subject said second recording materials on said post-processing tray to a post-processing and then discharge said second recording materials from said post-processing tray onto a recording-material discharge tray, and said first discharge section is adapted to discharge said second recording materials fed from said recording-material feed means and color-printed by said second image formation means, directly onto said recording-material discharge tray,
(d) job-process-continuation-signal input means for entering said job-process-continuation signal therethrough, wherein said job-process-continuation-signal input means is adapted to allow said job-process-continuation signal to be output to said computer only after said first recording materials with monochrome images formed by said first image forming apparatus are set on said post-processing tray of said post-processing device,
(e) second communication means for allowing data communication with said computer via said network, and
(f) image-formation control means for controlling respective operations of said second image formation means, said recording-material feed means, said post-processing device, said job-process-continuation-signal input means and said second communication means, and
said image-formation control means has:
(1) a function of switching an operation of said post-processing device in such a manner that in response to said job-process-continuation signal entered from said job-process-continuation-signal input means, said second recording materials color-printed by said second image formation means are discharged directly onto said recording-material discharge tray through said first discharge section, and said post-processing section serving as a second discharge section to discharge said first recording materials set on said post-processing tray, onto said recording-material discharge tray without subjecting said first recording materials set on said post-processing tray to said post-processing, and
(2) a recording-material mixing function of checking said page numbers of said color print job data transmitted from said computer, and switching respective operations of said recording-material feed means and said post-processing means to allow color pages and monochrome pages to be mixed together while serializing their page numbers in a sequential order.

2. An image forming system comprising a plurality of image forming apparatuses and a computer, which are connected with each other via a network, wherein each of said image forming apparatuses is adapted to be operated in accordance with job data from said computer, wherein
said computer has:
(a) a page-number appending function of appending page numbers onto said job data,
(b) a job-data dividing function of dividing said job data in accordance with a given dividing rule,
(c) a job-data allocating function of allocating plural job data divided through said job-data dividing function, respectively, to specified image forming apparatuses, and
(d) a data-transmitting/receiving function of transmitting said plural job data allocated through said job-data allocating function, to said corresponding image forming apparatuses via said network,
at least one of said image forming apparatuses includes:
(a) image formation means for forming an image on each of first recording materials in order of page number in accordance with said job data transmitted from said computer,
(b) recording-material feed means for feeding said first recording materials to said image formation means,
(c) a post-processing device having a post-processing section with a post-processing tray, and a first discharge section, wherein
said post-processing section is adapted to guide said first recording materials fed from said recording-material feed means and formed with images, to said post-processing tray, so as to subject said first recording materials on said post-processing tray to a post-processing and then discharge said first recording materials from said post-processing tray onto a recording-material discharge tray, and
said first discharge section is adapted to discharge said first recording materials fed from said recording-material feed means and formed with images, directly onto said recording-material discharge tray,
(d) job-process-continuation-signal input means for entering a job-process-continuation-signal therethrough, wherein said job-process-continuation-signal input means is adapted to allow said job-process-continuation signal to be output to said computer only after second recording materials with images formed by another one of said image forming apparatuses are set on said post-processing tray of said post-processing device,
(e) communication means for allowing data communication with said computer via said network, and
(f) image-formation control means for controlling respective operations of said image formation means, said recording-material feed means, said post-processing device, said job-process-continuation-signal input means and said communication means, and
said image-formation control means has:
(1) a function of switching an operation of said post-processing device in such a manner that in response to said job-process-continuation signal entered from said job-process-continuation-signal input means, said first recording materials with images formed by said image formation means are discharged directly onto said recording-material discharge tray through said first discharge section, and said post-processing section serves as a second discharge section to discharge said second recording materials from said post-processing tray onto said recording-material discharge tray without subjecting said second recording materials set on said post-processing tray to said post-processing, and
(2) a recording-material mixing function of checking said page numbers of said job data transmitted from said computer, and switching said respective operations of said recording-material feed means and said post-processing device to allow said second recording materials with images formed by said another image forming apparatus and said first recording materials with images formed by said image formation means to be mixed together while serializing their page numbers in a sequential order.

3. An image forming system comprising a plurality of image forming apparatuses and a computer, which are connected with each other via a network, wherein each of said image forming apparatuses is adapted to be operated in accordance with job data from said computer, wherein
said computer has:
(a) a page-number appending function of appending page numbers onto said job data,
(b) a job-data dividing function of dividing said job data in accordance with a given dividing rule,
(c) a job-data allocating function of allocating plural job data divided through said job-data dividing function, respectively, to specified image forming apparatuses, and
(d) a data-transmitting/receiving function of transmitting said plural job data allocated through said job-data allocating function, to said corresponding image forming apparatuses via said network,
at least one of said plurality of image forming apparatuses includes:
(a) image formation means for forming an image on each of first recording materials in order of page number in accordance with said job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials on said double-side-printing intermediate tray to said image formation means,
(d) a third recording-material feed means having a recording-material receiving section for placing thereon second recording materials with images formed by another one of said image forming apparatuses in order of page number, wherein said third recording-material feed means is adapted to feed said second recording materials placed on said recording-material receiving section to said image formation means,
(e) job-process-continuation-signal input means for entering a signal for initiating to feed said first and second recording materials through said second and third recording-material feed means, respectively, wherein said job-process-continuation-signal input means is adapted to allow said signal to be entered therethrough only after said second recording materials are set on said recording-material receiving section of said third recording-material feed means,
(f) recording-material discharge means for discharging said first and second recording materials fed from said second and third recording-material feed means, onto a recording-material discharge tray,
(g) communication means for allowing data communication with said computer via said network, and
(h) image-formation control means for controlling respective operations of said image formation means, said first to third recording-material feed means, said job-process-continuation-signal input means, said recording-material discharge means and said communication means, and
said image-formation control means has:
(1) a printing ON/OFF function of operating said image formation means to form images on said first recording materials during a feeding of said first recording materials through said first recording-material feed means, and disabling a printing operation of said image formation means in response to said signal entered from said job-process-continuation signal input means, and
(2) a function of checking said page numbers of said job data transmitted from said computer, and switching respective operations of said second recording-material feed means and said third recording-material feed means to allow said second recording materials with images formed by said another image forming apparatus and said first recording materials with images formed by said image formation means to be mixed together while serializing their page numbers in a sequential order.

4. An image forming system comprising a plurality of image forming apparatuses and a computer, which are connected with each other via a network, wherein each of said image forming apparatuses is adapted to be operated in accordance with job data from said computer, wherein
said computer has:
(a) a page-number appending function of appending page numbers onto said job data,
(b) a job-data dividing function of dividing said job data in accordance with a given dividing rule,
(c) a job-data allocating function of allocating plural job data divided through said job-data dividing function, respectively, to specified image forming apparatuses, and
(d) a data-transmitting/receiving function of transmitting said plural job data allocated through said job-data allocating function, to said corresponding image forming apparatuses via said network,
at least one of said plurality of image forming apparatuses includes:
(a) image formation means for forming an image on each of first recording materials in order of page number in accordance with said job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials from said double-side-printing intermediate tray to said image formation means,
(d) a post-processing device having a post-processing section with a post-processing tray, and a first discharge section, wherein said post-processing section is adapted to guide said first recording materials fed from either one of said first and second recording-material feed means and formed with images, onto said post processing tray so as to subject said first recording materials on said post-processing tray to a post-processing and then discharge said first recording materials from said post-processing tray onto a recording-material discharge tray, and said first discharge section is adapted to discharge said first recording materials fed from either one of said first and second recording-material feed means and formed with images, directly onto said recording-material discharge tray,
(e) job-process-continuation-signal input means for entering a signal for initiating an operation of mixing said first recording materials fed through said second recording-material feed means, and second recording materials with images formed by another one of said image forming apparatuses, wherein said job-process-continuation-signal input means is adapted to allow said signal to be entered therethrough only after said second recording materials are set on said post-processing tray of said post-processing device,
(f) communication means for allowing data communication with said computer via said network, and
(g) image-formation control means for controlling respective operations of said image formation means, said first and second recording-material feed means, said post-processing device, said job-process-continuation-signal input means, and said communication means, and
said image-formation control means has:
(1) a printing ON/OFF function of operating said image formation means to form images on said first recording materials during said feeding of said first recording materials through said first recording-material feed means without said signal to be entered from said job-process-continuation-signal input means, and disabling a printing operation of said image formation means in response to said signal entered from said job-process-continuation signal input means,
(2) a function of switching an operation of said post-processing device in such a manner that when said signal is entered from said job-process-continuation-signal input means, and said first recording materials are fed through said second recording-material feed means, said first recording materials fed from said second recording-material feed means are discharged directly onto said recording-material discharge tray through said first discharge section, and said post-processing section serves as a second discharge section to discharge said second recording materials from said post-processing tray onto said recording-material discharge tray without subjecting said second recording materials placed on said post-processing tray to said post-processing, and
(3) a recording-material mixing function of checking said page numbers of said job data transmitted from said computer, and switching respective operations of said second recording-material feed means and said post-processing section to allow said second recording materials with images formed by said another image forming apparatus and said first recording materials with images formed by said image formation means to be mixed together while serializing their page numbers in a sequential order.

5. An image forming apparatus capable of performing color printing, wherein said image forming apparatus is connected to a computer via a network together with another image forming apparatus capable of performing only monochrome printing, wherein
said image forming apparatus includes:
(a) image formation means for forming a color image on each of first recording materials in order of page number in accordance with color print job data transmitted from said computer,
(b) recording-material feed means for feeding said first recording materials to said image formation means,
(c) a post-processing device having a post-processing section with a post-processing tray, and a first discharge section, wherein said post-processing section is adapted to guide said first recording materials fed from said recording-material feed means and color-printed by said image formation means, to said post-processing tray, so as to subject said first recording materials on said post-processing tray to a post-processing and then discharge said first recording materials from said post-processing tray onto a recording-material discharge tray, and said first discharge section is adapted to discharge said recording materials fed from said recording-material feed means and color-printed by said image formation means, directly onto said recording-material discharge tray,
(d) job-process-continuation-signal input means for entering said job-process-continuation signal therethrough, wherein said job-process-continuation-signal input means is adapted to allow said job-process-continuation signal to be output to said computer only after second recording materials with monochrome images formed by said another image forming apparatus are set on said post-processing tray of said post-processing device,
(e) communication means for allowing data communication with said computer via said network, and
(f) image-formation control means for controlling respective operations of said image formation means, said recording-material feed means, said post-processing device, said job-process-continuation-signal input means and said communication means, and
said image-formation control means has:
(1) a function of switching an operation of said post-processing device in such a manner that in response to said job-process-continuation signal entered from said job-process-continuation-signal input means, said first recording materials color-printed by said image formation means are discharged directly onto said recording-material discharge tray through said first discharge section, and said post-processing section serves as a second discharge section to discharge said second recording materials set on said post-processing tray onto said recording-material discharge tray without subjecting said second recording materials set on said post-processing tray to said post-processing, and
(2) a recording-material mixing function of checking said page numbers of said color print job data transmitted from said computer, and switching respective operations of said recording-material feed means and said post-processing means to allow color pages and monochrome pages to be mixed together while serializing their page numbers in a sequential order.

6. An image forming apparatus connected to a computer via a network together with another image forming apparatuses, wherein
said image forming apparatus includes:
(a) image formation means for forming an image on each of first recording materials in order of page number in accordance with job data transmitted from said computer,
(b) recording-material feed means for feeding said first recording materials to said image formation means,
(c) a post-processing device having a post-processing section with a post-processing tray, and a first discharge section, wherein
said post-processing section is adapted to guide said first recording materials fed from said recording-material feed means and formed with images, to said post-processing tray, so as to subject said first recording materials on said post-processing tray to a post-processing and then discharge said first recording materials from said post-processing tray onto a recording-material discharge tray, and
said first discharge section is adapted to discharge said first recording materials fed from said recording-material feed means and formed with images, directly onto said recording-material discharge tray,
(d) job-process-continuation-signal input means for entering a job-process-continuation signal therethrough, wherein said job-process-continuation-signal input means is adapted to allow said job-process-continuation signal to be output to said computer only after second recording materials with images formed by said another image forming apparatus are set on said post-processing tray of said post-processing device,
(e) communication means for allowing data communication with said computer via said network, and
(f) image-formation control means for controlling respective operations of said image formation means, said recording-material feed means, said post-processing device, said job-process-continuation-signal input means and said communication means, and
said image-formation control means has:
(1) a function of switching an operation of said post-processing device in such a manner that in response to said job-process-continuation signal entered from said job-process-continuation-signal input means, said first recording materials with images formed by said image formation means are discharged directly onto said recording-material discharge tray through said first discharge section, and said post-processing section serves as a second discharge section to discharge said second recording materials from said post-processing tray onto said recording-material discharge tray without subjecting said second recording materials set on said post-processing tray to said post-processing, and
(2) a recording-material mixing function of checking said page numbers of said job data transmitted from said computer, and switching respective operations of said recording-material feed means and said post-processing device to allow said second recording materials with images formed by said another image forming apparatus and said first recording materials with images formed by said image formation means to be mixed together while serializing their page numbers in a sequential order.

7. An image forming apparatus connected to a computer via a network together with another image forming apparatuses, wherein
said image forming apparatus includes:
(a) image formation means for forming an image on each of first recording materials in order of page number in accordance with job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials on said double-side-printing intermediate tray to said image formation means,
(d) a third recording-material feed means having a recording-material receiving section for placing thereon second recording materials with images formed by said another image forming apparatus in order of page number, wherein said third recording-material feed means is adapted to feed said second recording materials placed on said recording-material receiving section to said image formation means,
(e) job-process-continuation-signal input means for entering a signal for initiating to feed said first and second recording materials through said second and third recording-material feed means, respectively, wherein said job-process-continuation-signal input means is adapted to allow said signal to be entered therethrough only after said second recording materials are set on said recording-material receiving section of said third recording-material feed means,
(f) recording-material discharge means for discharging said first and second recording materials fed from said second and third recording-material feed means, onto a recording-material discharge tray,
(g) communication means for allowing data communication with said computer via said network, and
(h) image-formation control means for controlling said respective operations of image formation means, said first to third recording-material feed means, said job-process-continuation-signal input means, said recording-material discharge means and said communication means, and
said image-formation control means has:
(1) a printing ON/OFF function of operating said image formation means to form images on said first recording materials during said feeding of said first recording materials through said first recording-material feed means, and disabling said printing operation of said image formation means in response to said signal entered from said job-process-continuation signal input means, and
(2) a function of checking page numbers of said job data transmitted from said computer, and switching respective operations of said second recording-material feed means and said third recording-material feed means to allow said second recording materials with images formed by said another image forming apparatus and said first recording materials with images formed by said image formation means to be mixed together while serializing their page numbers in a sequential order.

8. An image forming apparatus connected to a computer via a network together with another image forming apparatuses, wherein said image forming apparatus includes:
(a) image formation means for forming an image on each of first recording materials in order of page number in accordance with said job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials from said double-side-printing intermediate tray to said image formation means,
(d) a post-processing device having a post-processing section with a post-processing tray, and a first discharge section, wherein said post-processing section is adapted to guide said first recording materials fed from either one of said first and second recording-material feed means and formed with images, onto said post processing tray, so as to subject said first recording materials on said post-processing tray to a post-processing and then discharge said first recording materials from said post-processing tray onto a recording-material discharge tray, and said first discharge section is adapted to discharge said first recording materials fed from either one of said first and second recording-material feed means and formed with images, directly onto said recording-material discharge tray,
(e) job-process-continuation-signal input means for entering a signal for initiating an operation of mixing said first recording materials fed through said second recording-material feed means, and second recording materials with images formed by another one of said image forming apparatuses, wherein said job-process-continuation-signal input means is adapted to allow said signal to be entered therethrough only after said second recording materials are set on said post-processing tray of said post-processing device,
(f) communication means for allowing data communication with said computer via said network, and
(g) image-formation control means for controlling respective operations of said image formation means, said first and second recording-material feed means, said post-processing device, said job-process-continuation-signal input means, and said communication means, and
said image-formation control means has:
(1) a printing ON/OFF function of operating said image formation means to form images on said first recording materials during said feeding of said first recording materials through said first recording-material feed means without said signal to be entered from said job-process-continuation-signal input means, and disabling a printing operation of said image formation means in response to said signal entered from said job-process-continuation signal input means,
(2) a function of switching an operation of said post-processing device in such a manner that when said signal is entered from said job-process-continuation-signal input means, and said first recording materials are fed through said second recording-material feed means, said first recording materials fed from said second recording-material feed means are discharged directly onto said recording-material discharge tray through said first discharge section, and said post-processing section serves as a second discharge section to discharge said second recording materials from said post-processing tray onto said recording-material discharge tray without subjecting said second recording materials placed on said post-processing tray to said post-processing, and
(3) a recording-material mixing function of checking page numbers of said job data transmitted from said computer, and switching respective operations of said second recording-material feed means and said post-processing section to allow said second recording materials with images formed by said another image forming apparatus and said first recording materials with images formed by said image formation means to be mixed together while serializing their page numbers in a sequential order.

9. An operation control method for an image forming apparatus capable of performing color printing, wherein said image forming apparatus is connected to a computer via a network together with another image forming apparatus capable of performing only monochrome printing, and provided with:
(a) image formation means for forming a color image on each of first recording materials in order of page number in accordance with color print job data transmitted from said computer,
(b) recording-material feed means for feeding said first recording materials to said image formation means,
(c) a post-processing device having a post-processing section with a post-processing tray, and a first discharge section, wherein said post-processing section is adapted to guide said first recording materials fed from said recording-material feed means and color-printed by said image formation means, to said post-processing tray, so as to subject said first recording materials on said post-processing tray to a post-processing and then discharge said first recording materials from said post-processing tray onto a recording-material discharge tray, and said first discharge section is adapted to discharge said first recording materials fed from recording-material feed means and color-printed by said image formation means, directly onto said recording-material discharge tray,
(d) job-process-continuation-signal input means for entering said job-process-continuation signal therethrough, wherein said job-process-continuation-signal input means is adapted to allow said job-process-continuation signal to be output to said computer only after second recording materials with monochrome images formed by said another image forming apparatus are set on said post-processing tray of said post-processing device,
(e) communication means for allowing data communication with said computer via said network, and
(f) image-formation control means for controlling respective operations of said image formation means, said recording-material feed means, said post-processing device, said job-process-continuation-signal input means and said communication means, and
said operation control method comprises operating said image-formation control means to perform:
(1) a function of switching an operation of said post-processing device in such a manner that in response to said job-process-continuation signal entered from said job-process-continuation-signal input means, said first recording materials color-printed by said image formation means are discharged directly onto said recording-material discharge tray through said first discharge section, and said post-processing section serves as a second discharge section to discharge said second recording materials set on said post-processing tray onto said recording-material discharge tray without subjecting said second recording materials set on said post-processing tray to said post-processing, and
(2) a recording-material mixing function of checking said page numbers of said color print job data transmitted from said computer, and switching respective operations of said recording-material feed means and said post-processing means to allow color pages and monochrome pages to be mixed together while serializing their page numbers in a sequential order.

10. An operation control method for an image forming apparatus connected to a computer via a network together with another image forming apparatuses, wherein
said image forming apparatus includes:
(a) image formation means for forming an image on each of first recording materials in order of page number in accordance with job data transmitted from said computer,
(b) recording-material feed means for feeding said first recording materials to said image formation means,
(c) a post-processing device having a post-processing section with a post-processing tray, and a first discharge section, wherein
said post-processing section is adapted to guide said first recording materials fed from said recording-material feed means and formed with images, to said post-processing tray, so as to subject said first recording materials on said post-processing tray to a post-processing and then discharge said first recording materials from said post-processing tray onto a recording-material discharge tray, and
said first discharge section is adapted to discharge said first recording materials fed from said recording-material feed means and formed with images, directly onto said recording-material discharge tray,
(d) job-process-continuation-signal input means for entering a job-process-continuation signal therethrough, wherein said job-process-continuation-signal input means is adapted to allow said job-process-continuation signal to be output to said computer only after second recording materials with images formed by said another image forming apparatus are set on said post-processing tray of said post-processing device,
(e) communication means for allowing data communication with said computer via said network, and
(f) image-formation control means for controlling said respective operations of said image formation means, said recording-material feed means, said post-processing device, said job-process-continuation-signal input means and said communication means, and
said operation control method comprises operating said image-formation control means to perform:
(1) a function of switching an operation of said post-processing device in such a manner that in response to said job-process-continuation signal entered from said job-process-continuation-signal input means, said first recording materials with images formed by said image formation means are discharged directly onto said recording-material discharge tray through said first discharge section, and said post-processing section serves as a second discharge section to discharge said second recording materials from said post-processing tray onto said recording-material discharge tray without subjecting said second recording materials set on said post-processing tray to said post-processing, and
(2) a recording-material mixing function of checking said page numbers of said job data transmitted from said computer, and switching respective operations of said recording-material feed means and said post-processing device to allow said second recording materials with images formed by said another image forming apparatus and said first recording materials with images formed by said image formation means to be mixed together while serializing their page numbers in a sequential order.

11. An operation control method for an image forming apparatus connected to a computer via a network together with another image forming apparatuses, wherein
said image forming apparatus includes:
(a) image formation means for forming an image on each of first recording materials in order of page number in accordance with job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials on said double-side-printing intermediate tray to said image formation means,
(d) a third recording-material feed means having a recording-material receiving section for placing thereon second recording materials with images formed by said another image forming apparatus in order of page number, wherein said third recording-material feed means is adapted to feed said second recording materials placed on said recording-material receiving section to said image formation means,
(e) job-process-continuation-signal input means for entering a signal for initiating to feed said first and second recording materials through said second and third recording-material feed means, respectively, wherein said job-process-continuation-signal input means is adapted to allow said signal to be entered therethrough only after said second recording materials are set on said recording-material receiving section of said third recording-material feed means,
(f) recording-material discharge means for discharging said first and second recording materials fed from said second and third recording-material feed means, onto a recording-material discharge tray,
(g) communication means for allowing data communication with said computer via said network, and
(h) image-formation control means for controlling respective operations of said image formation means, said first to third recording-material feed means, said job-process-continuation-signal input means, said recording-material discharge means and said communication means, and
said operation control method comprises operating said image-formation control means to perform:
(1) a printing ON/OFF function of operating said image formation means to form images on said first recording materials during said feeding of said first recording materials through said first recording-material feed means, and disabling said printing operation of said image formation means in response to said signal entered from said job-process-continuation signal input means, and
(2) a function of checking page numbers of said job data transmitted from said computer, and switching respective operations of said second recording-material feed means and said third recording-material feed means to allow said second recording materials with images formed by said another image forming apparatus and said first recording materials with images formed by said image formation means to be mixed together while serializing their page numbers in a sequential order.

12. An operation control method for an image forming apparatus connected to a computer via a network together with another image forming apparatuses, wherein
said image forming apparatus includes:
(a) image formation means for forming an image on each of first recording materials in order of page number in accordance with said job data transmitted from said computer, (b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials from said double-side-printing intermediate tray to said image formation means,
(d) a post-processing device having a post-processing section with a post-processing tray, and a first discharge section, wherein said post-processing section is adapted to guide said first recording materials fed from either one of said first and second recording-material feed means and formed with images, onto said post processing tray, so as to subject said first recording materials on said post-processing tray to a post-processing and then discharge said first recording materials from said post-processing tray onto a recording-material discharge tray, and said first discharge section is adapted to discharge said first recording materials fed from either one of said first and second recording-material feed means and formed with images, directly onto said recording-material discharge tray,
(e) job-process-continuation-signal input means for entering a signal for initiating an operation of mixing said first recording materials fed through said second recording-material feed means, and second recording materials with images formed by another one of said image forming apparatuses, wherein said job-process-continuation-signal input means is adapted to allow said signal to be entered therethrough only after said second recording materials are set on said post-processing tray of said post-processing device,
(f) communication means for allowing data communication with said computer via said network, and
(g) image-formation control means for controlling respective operations of said image formation means, said first and second recording-material feed means, said post-processing device, said job-process-continuation-signal input means, and said communication means, and
said operation control method comprises operating said image-formation control means to perform:
(1) a printing ON/OFF function of operating said image formation means to form images on said first recording materials during feeding of said first recording materials through said first recording-material feed means without said signal to be entered from said job-process-continuation-signal input means, and disabling a printing operation of said image formation means in response to said signal entered from said job-process-continuation signal input means,
(2) a function of switching an operation of said post-processing device in such a manner that when said signal is entered from said job-process-continuation-signal input means, and said first recording materials are fed through said second recording-material feed means, said first recording materials fed from said second recording-material feed means are discharged directly onto said recording-material discharge tray through said first discharge section, and said post-processing section serves as a second discharge section to discharge said second recording materials from said post-processing tray onto said recording-material discharge tray without subjecting said second recording materials placed on said post-processing tray to said post-processing, and
(3) a recording-material mixing function of checking page numbers of said job data transmitted from said computer, and switching respective operations of said second recording-material feed means and said post-processing section to allow said second recording materials with images formed by said another image forming apparatus and said first recording materials with images formed by said image formation means to be mixed together while serializing their page numbers in a sequential order.

13. A program product for verifying an operational status of a computer comprising:
(A) a control program for an image forming apparatus capable of performing color printing, wherein said image forming apparatus is connected to a computer via a network together with another image forming apparatus capable of performing only monochrome printing, and provided with:
(a) image formation means for forming a color image on each of first recording materials in order of page number in accordance with color print job data transmitted from said computer,
(b) recording-material feed means for feeding said first recording materials to said image formation means,
(c) a post-processing device having a post-processing section with a post-processing tray, and a first discharge section, wherein said post-processing section is adapted to guide said recording materials fed from said recording-material feed means and color-printed by said image formation means, to said post-processing tray, so as to subject said first recording materials on said post-processing tray to a post-processing and then discharge said first recording materials from said post-processing tray onto a recording-material discharge tray, and said first discharge section is adapted to discharge said first recording materials fed from said recording-material feed means and color-printed by said image formation means, directly onto said recording-material discharge tray,
(d) job-process-continuation-signal input means for entering said job-process-continuation signal therethrough, wherein said job-process-continuation-signal input means is adapted to allow said job-process-continuation signal to be output to said computer only after second recording materials with monochrome images formed by said another image forming apparatus are set on said post-processing tray of said post-processing device,
(e) communication means for allowing data communication with said computer via said network, and
(f) image-formation control means for controlling respective operations of said image formation means, said recording-material feed means, said post-processing means, said job-process-continuation-signal input means and said communication means, and
said control program comprises sequence of instructions to be executed within said image forming apparatus so as to allow said image-formation control means to perform:
(1) a function of switching an operation of said post-processing device in such a manner that in response to said job-process-continuation signal entered from said job-process-continuation-signal input means, said first recording materials color-printed by said image formation means are discharged directly onto said recording-material discharge tray through said first discharge section, and said post-processing section serves as a second discharge section to discharge said second recording materials set on said post-processing tray onto said recording-material discharge tray without subjecting said second recording materials set on said post-processing tray to said post-processing, and
(2) a recording-material mixing function of checking said page numbers of said color print job data transmitted from said computer, and switching respective operations of said recording-material feed means and said post-processing means to allow color pages and monochrome pages to be mixed together while serializing their page numbers in a sequential order, and
(B) a signal bearing media bearing said control program.

14. The program product of claim 13, wherein said signal bearing media comprises at least one of a transmission-type media and a recordable media.

15. A program product for verifying an operational status of a computer comprising:
(A) a control program for an image forming apparatus connected to a computer via a network together with another image forming apparatuses, wherein
said image forming apparatus includes:
(a) image formation means for forming an image on each of first recording materials in order of page number in accordance with job data transmitted from said computer,
(b) recording-material feed means for feeding said first recording materials to said image formation means,
(c) a post-processing device having a post-processing section with a post-processing tray, and a first discharge section, wherein
said post-processing section is adapted to guide said first recording materials fed from said recording-material feed means and formed with images, to said post-processing tray, so as to subject said first recording materials on said post-processing tray to a post-processing and then discharge said first recording materials from said post-processing tray onto a recording-material discharge tray, and
said first discharge section is adapted to discharge said first recording materials fed from said recording-material feed means and formed with images, directly onto said recording-material discharge tray,
(d) job-process-continuation-signal input means for entering a job-process-continuation signal therethrough, wherein said job-process-continuation-signal input means is adapted to allow said job-process-continuation signal to be output to said computer only after second recording materials with images formed by said another image forming apparatus are set on said post-processing tray of said post-processing device,
(e) communication means for allowing data communication with said computer via said network, and
(f) image-formation control means for controlling said respective operations of said image formation means, said recording-material feed means, said post-processing device, said job-process-continuation-signal input means and said communication means, and
said control program comprises sequence of instructions to be executed within said image forming apparatus so as to allow said image-formation control means to perform:
(1) a function of switching an operation of said post-processing device in such a manner that in response to said job-process-continuation signal entered from said job-process-continuation-signal input means, said first recording materials with images formed by said image formation means are discharged directly onto said recording-material discharge tray through said first discharge section, and said post-processing section serves as a second discharge section to discharge said second recording materials from said post-processing tray onto said recording-material discharge tray without subjecting said second recording materials set on said post-processing tray to said post-processing, and
(2) a recording-material mixing function of checking page numbers of said job data transmitted from said computer, and switching respective operations of said recording-material feed means and said post-processing device to allow said second recording materials with images formed by said another image forming apparatus and said first recording materials with images formed by said image formation means to be mixed together while serializing their page numbers in a sequential order, and
(B) a signal bearing media bearing said control program.

16. The program product of claim 15, wherein said signal bearing media comprises at least one of a transmission-type media and a recordable media.

17. A program product for verifying an operational status of a computer comprising:
(A) a control program for an image forming apparatus connected to a computer via a network together with another image forming apparatuses, wherein
said image forming apparatus includes:
(a) image formation means for forming an image on each of first recording materials in order of page number in accordance with job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials on said double-side-printing intermediate tray to said image formation means,
(d) a third recording-material feed means having a recording-material receiving section for placing thereon second recording materials with images formed by said another image forming apparatus in order of page number, wherein said third recording-material feed means is adapted to feed said second recording materials placed on said recording-material receiving section to said image formation means,
(e) job-process-continuation-signal input means for entering a signal for initiating to feed said first and second recording materials through said second and third recording-material feed means, respectively, wherein said job-process-continuation-signal input means is adapted to allow said signal to be entered therethrough only after said second recording materials are set on said recording-material receiving section of said third recording-material feed means,
(f) recording-material discharge means for discharging said first and second recording materials fed from said second and third recording-material feed means, onto a recording-material discharge tray,
(g) communication means for allowing data communication with said computer via said network, and
(h) image-formation control means for controlling respective operations of said image formation means, said first to third recording-material feed means, said job-process-continuation-signal input means, said recording-material discharge means and said communication means, and
said control program comprises sequence of instructions to be executed within said image forming apparatus so as to allow said image-formation control means to perform:
(1) a printing ON/OFF function of operating said image formation means to form images on said first recording materials during feeding of said first recording materials through said first recording-material feed means, and disabling printing operation of said image formation means in response to said signal entered from said job-process-continuation signal input means, and
(2) a function of checking page numbers of said job data transmitted from said computer, and switching respective operations of said second recording-material feed means and said third recording-material feed means to allow said second recording materials with images formed by said another image forming apparatus and said first recording materials with images formed by said image formation means to be mixed together while serializing their page numbers in a sequential order, and
(B) a signal bearing media bearing said control program.

18. The program product of claim 17, wherein said signal bearing media comprises at least one of a transmission-type media and a recordable media.

19. A program product for verifying an operational status of a computer comprising:
(A) a control program for an image forming apparatus connected to a computer via a network together with another image forming apparatuses, wherein
said image forming apparatus includes:
(a) image formation means for forming an image on each of first recording materials in order of page number in accordance with job data transmitted from said computer,
(b) a first recording-material feed means for feeding said first recording materials to said image formation means,
(c) a second recording-material feed means having a double-side-printing intermediate tray, wherein said second recording-material feed means is adapted to place said first recording materials fed from said first recording-material feed means and formed with images, onto said double-side-printing intermediate tray, and then feed said first recording materials from said double-side-printing intermediate tray to said image formation means,
(d) a post-processing device having a post-processing section with a post-processing tray, and a first discharge section, wherein said post-processing section is adapted to guide said first recording materials fed from either one of said first and second recording-material feed means and formed with images, onto said post processing tray, so as to subject said first recording materials on said post-processing tray to a post-processing and then discharge said first recording materials from said post-processing tray onto a recording-material discharge tray, and said first discharge section is adapted to discharge said first recording materials fed from either one of said first and second recording-material feed means and formed with images, directly onto said recording-material discharge tray,
(e) job-process-continuation-signal input means for entering a signal for initiating an operation of mixing said first recording materials fed through said second recording-material feed means, and second recording materials with images formed by another one of said image forming apparatuses, wherein said job-process-continuation-signal input means is adapted to allow said signal to be entered therethrough only after said second recording materials are set on said post-processing tray of said post-processing device,
(f) communication means for allowing data communication with said computer via said network, and
(g) image-formation control means for controlling respective operations of said image formation means, said first and second recording-material feed means, said post-processing device, said job-process-continuation-signal input means, and said communication means, and
said control program comprises sequence of instructions to be executed within said image forming apparatus so as to allow said image-formation control means to perform:
(1) a printing ON/OFF function of operating said image formation means to form images on said first recording materials during feeding of said first recording materials through said first recording-material feed means without said signal to be entered from said job-process-continuation-signal input means, and disabling a printing operation of said image formation means in response to said signal entered from said job-process-continuation signal input means,
(2) a function of switching an operation of said post-processing device in such a manner that when said signal is entered from said job-process-continuation-signal input means, and said first recording materials are fed through said second recording-material feed means, said first recording materials fed from said second recording-material feed means are discharged directly onto said recording-material discharge tray through said first discharge section, and said post-processing section serves as a second discharge section to discharge said second recording materials from said post-processing tray onto said recording-material discharge tray without subjecting said second recording materials placed on said post-processing tray to said post-processing, and
(3) a recording-material mixing function of checking page numbers of said job data transmitted from said computer, and switching respective operations of said second recording-material feed means and said post-processing section to allow said second recording materials with images formed by said another image forming apparatus and said first recording materials with images formed by said image formation means to be mixed together while serializing their page numbers in a sequential order, and
(B) a signal bearing media bearing said control program.

20. The program product of claim 19, wherein said signal bearing media comprises at least one of a transmission-type media and a recordable media.
